(19) United States
(12) Patent Application Publication
(10) Pub. No.: US 2026/0303680 A1
(43) Pub. Date: Oct. 1, 2026

(54) RESOURCE ALLOCATION AND MANAGEMENT OF XRM SERVICES

(71) Applicant: Samsung Electronics Co., Ltd., Suwon-si (KR)

(72) Inventor: Prakash Reddy Kolan, Plano, TX (US)

(21) Appl. No.: 19/568,563

(22) Filed: Mar. 16, 2026

Related U.S. Application Data
(60) Provisional application No. 63/778,099, filed on Mar. 26, 2025.
(60) Provisional application No. 63/786,079, filed on Apr. 9, 2025.
(60) Provisional application No. 63/887,959, filed on Sep. 25, 2025.
(60) Provisional application No. 63/897,112, filed on Oct. 10, 2025.

(51) Int. Cl. H04L 65/80; H04L 65/60

(52) U.S. Cl. CPC H04L 65/80; H04L 65/60

(57) ABSTRACT

A method of operating a network function includes receiving, from an application service provider, a service/session configuration permitting a radio resource saving operation with a user equipment (UE) operating on a network of the network function. The method also includes receiving a first indication indicating that the UE has completed an initial content fetch of extended reality media (XRM) content from the application service provider, and in response to receiving the first indication, initiating the radio resource saving operation between the UE and the network. The method further includes receiving a second indication indicating receipt of additional XRM content for the UE from the application service provider, and in response to receiving the second indication, initiating a termination of the radio resource saving operation between the UE and the network of the network function.

### CROSS-REFERENCE TO RELATED APPLICATIONS AND CLAIM OF PRIORITY

This application claims priority under 35 U.S.C. § 119(e) to U.S. Provisional Patent Application No. 63/778,099 filed on Mar. 26, 2025, U.S. Provisional Patent Application No. 63/786,079 filed on Apr. 9, 2025, U.S. Provisional Patent Application No. 63/887,959 filed on Sep. 25, 2025, and U.S. Provisional Patent Application No. 63/897,112 filed on Oct. 10, 2025. The above-identified provisional patent applications are hereby incorporated by reference in their entirety.

### TECHNICAL FIELD

This disclosure relates generally to wireless networks. More specifically, this disclosure relates to resource allocation and management of extended reality media (XRM) services, for example in wireless networks such as 5G Networks.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for resource allocation and management of XRM services, for example in wireless networks such as 5G networks.

In one embodiment, a method of operating a network function is provided. The method includes receiving, from an application service provider, a service/session configuration permitting a radio resource saving operation with a user equipment (UE) operating on a network of the network function. The method also includes receiving a first indication indicating that the UE has completed an initial content fetch of extended reality media (XRM) content from the application service provider, and in response to receiving the first indication, initiating the radio resource saving operation between the UE and the network. The method further includes receiving a second indication indicating receipt of additional XRM content for the UE from the application service provider, and in response to receiving the second indication, initiating a termination of the radio resource saving operation between the UE and the network of the network function.

In another an electronic device is provided. The electronic device includes at least one processor including processing circuitry, and memory storing instructions. The instructions, when executed by the at least one processor individually or collectively, cause the electronic device to receive, from an application service provider, a service/session configuration permitting a radio resource saving operation with a UE operating on a network of the electronic device. The instructions, when executed by the at least one processor individually or collectively, also cause the electronic device to receive a first indication indicating that the UE has completed an initial content fetch of XRM content from the application service provider, and in response to receiving the first indication, initiate the radio resource saving operation between the UE and the network. The instructions, when executed by the at least one processor individually or collectively, further cause the electronic device to receive a second indication indicating receipt of additional XRM content for the UE from the application service provider, and in response to receiving the second indication, initiate a termination of the radio resource saving operation between the UE and the network of the electronic device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates an example 5GMS architecture according to embodiments of the present disclosure;

FIG. 5 illustrates an example architecture for information exposure of XRM services according to embodiments of the present disclosure;

FIG. 6 illustrates an example procedure for XRM service configuration according to embodiments of the present disclosure;

FIG. 7 illustrates an example procedure for XRM service configuration for initial content fetch according to embodiments of the present disclosure;

FIG. 8 illustrates an example procedure for XRM Service configuration for radio resource and power savings according to embodiments of the present disclosure;

FIG. 9 illustrates an example procedure for Managing PDUs in an NG-RAN based on UE application adaptation according to embodiments of the present disclosure;

FIG. 10 illustrates an example procedure for managing PDUs in an NG-RAN based on UE application adaptation feedback according to embodiments of the present disclosure;

FIG. 11 illustrates an example procedure for managing PDUs in an NG-RAN based on UE application adaptation feedback at the network/physical layer according to embodiments of the present disclosure;

FIG. 12 illustrates an example procedure for radio resource and power savings based on feedback from a UE according to embodiments of the present disclosure;

FIG. 13 illustrates an example procedure for radio resource and power savings in an NG-RAN and a UE based on application traffic characteristics according to embodiments of the present disclosure;

FIG. 14 illustrates an example procedure for a temporary service boost for XRM service according to embodiments of the present disclosure

FIG. 15 illustrates an example procedure for radio resource and power savings in an NG-RAN and UE based on application burst configuration and UE feedback according to embodiments of the present disclosure;

FIG. 16 illustrates an example procedure for radio resource and power savings in an NG-RAN and UE based on traffic distribution information according to embodiments of the present disclosure;

FIG. 17 illustrates an example of tethered devices behind a UE for XRM services according to embodiments of the present disclosure;

FIG. 18 illustrates an example tethering agent in a UE managing tethered devices according to embodiments of the present disclosure;

FIG. 19 illustrates an example procedure for tethered device data management based on current QoS according to embodiments of the present disclosure;

FIG. 20 illustrates an example procedure for delegation of QoS management to a tethering UE according to embodiments of the present disclosure;

FIG. 21 illustrates an example exposure of capabilities of tethered devices and tethered links to the network according to embodiments of the present disclosure;

FIG. 22 illustrates an example procedure for delegation of content preparation to a tethering UE according to embodiments of the present disclosure;

FIG. 23 illustrates an example procedure for content hosting of media data of different tethered devices according to embodiments of the present disclosure;

FIG. 24 illustrates an example procedure for content management based on the energy status of tethered devices according to embodiments of the present disclosure;

FIG. 25 illustrates an example procedure for UE assisted content adaptation based on the energy status of tethered devices according to embodiments of the present disclosure;

FIG. 26 illustrates another example procedure for content management based on the energy status of tethered devices according to embodiments of the present disclosure;

FIG. 27 illustrates another example procedure for content management based on the energy status of tethered devices according to embodiments of the present disclosure; and

FIG. 28 illustrates an example method for resource allocation and management of XRM services according to embodiments of the present disclosure.

### DETAILED DESCRIPTION

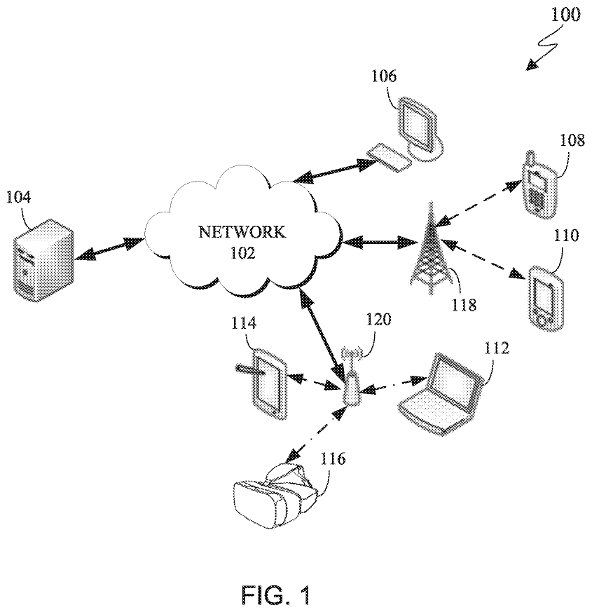

FIGS. 1 through 28, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a HMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

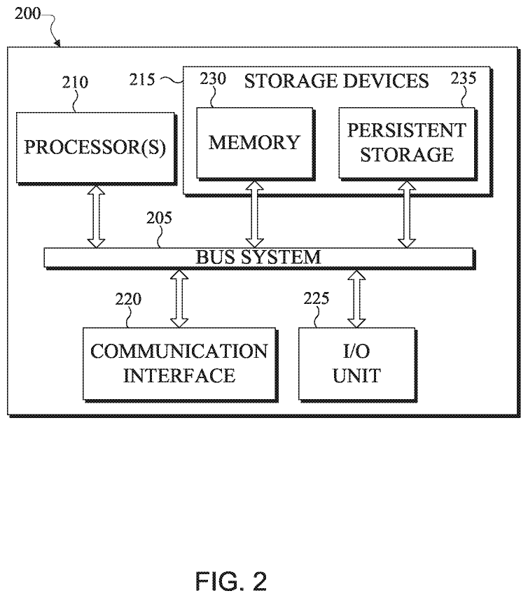

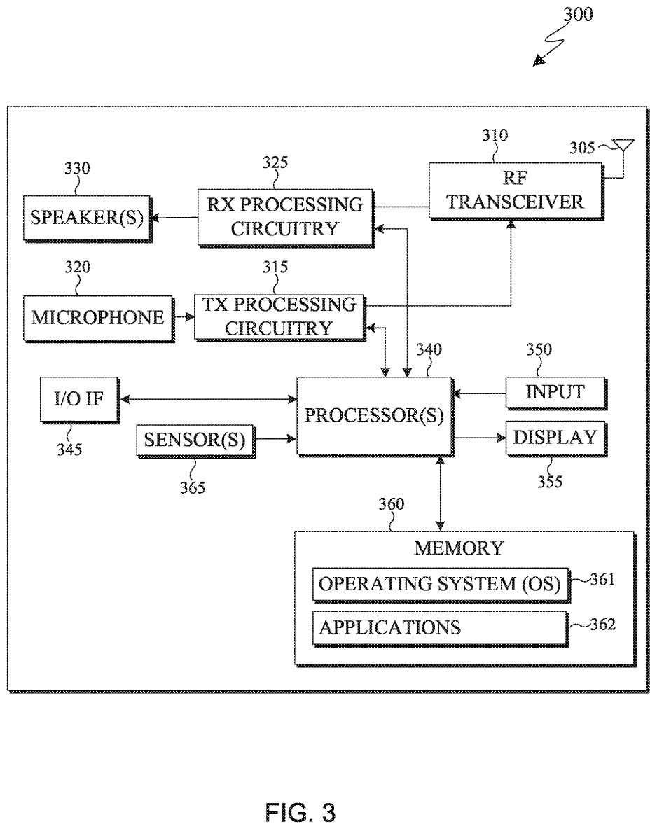

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s).

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as processes for resource allocation and management of XRM services. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Next generation applications and services with varied capabilities and requirements are being studied for deployment in 5G and 5G-Advanced networks. Applications with capabilities that were not possible for older 4G, and LTE networks are being investigated for deployment. The newer capabilities and inherent technologies of 5G networks such as differentiated service deployment with multi-level Quality of Service, network slicing, transmission and reception using multiple access networks etc. are driving such a demand of next generation complex application development. While the complexity of applications in next generation services have increased multifold, the hardware and software demand, network demands, and energy demands for these applications have also simultaneously increased. For successful deployment of next generation applications and services, it is not only imperative that application complexity be increased, but it is equally important that the applications be optimized and enhanced to work with lower hardware, software, and network demands.

For successful deployment of next generation applications and services with 5G and 5G-Advanced Networks, these applications and services have to be optimized when there are multiple demands. One such demand is energy, because performing complex actions and computations in these applications and services often requires an extreme amount of energy consumption to run the applications and services on end user devices and network locations. As a result of extreme carbon emissions and pollution, there has been increased awareness, and intent, from telecommunication service providers, network operators, UE device manufacturers, network equipment vendors etc. to develop hardware and software capabilities while decreasing energy requirements. Towards this effort, multiple standard organizations, academia, and enterprises have started building energy efficient architectures, products and solutions. Various embodiments of the present disclosure provide methods for energy monitoring, exposure, and enforcement to optimize energy consumption in mobile network terminal devices.

The newer 5G networks, and soon to be arriving 6G networks, are enabling development of next generation applications and services across a wide spectrum of domains and fields. Applications and services are being developed to take advantage of the capabilities of these 5G and 6G networks. Further, adaptive capabilities are being introduced into the 5G system to help these applications adapt to changing network conditions and government regulations. End to end systems in the 5G and 6G network have to interwork to enable an adaptive cellular network environment where application requirements can be optimized, and at the same time, the cost for deployment and cost of operations are reduced for the network operator.

One of the important problems being discussed and worked on right now in the world is to tackle the problem global climate change. One of the issues the operators of 5G and 6G networks are looking into to reduce the impact on global climate change is energy conservation while deploying and operating next generation cellular network applications and services. Towards these objectives, steps are being taken to actively measure energy consumption of different entities involved in application traffic for next generation applications and services. Various embodiments of the present disclosure provide methods for energy consumption measurement and providing feedback information to UE application components to help with application optimization while reducing application demands on energy.

In various embodiments of the present disclosure, a communication system such as communications system 100 may include one or more of an Application Function (AF), Access and Mobility Function (AMF), Policy Control Function (PCF), Session Management Function (SMF), and a User Plane Function (UPF). As described herein, an AF, AMF, PCF, SMF, and a UPF can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain functions may be executed by hardware components to achieve high performance, while other functions may be performed by software modules to provide flexibility and ease of updates.

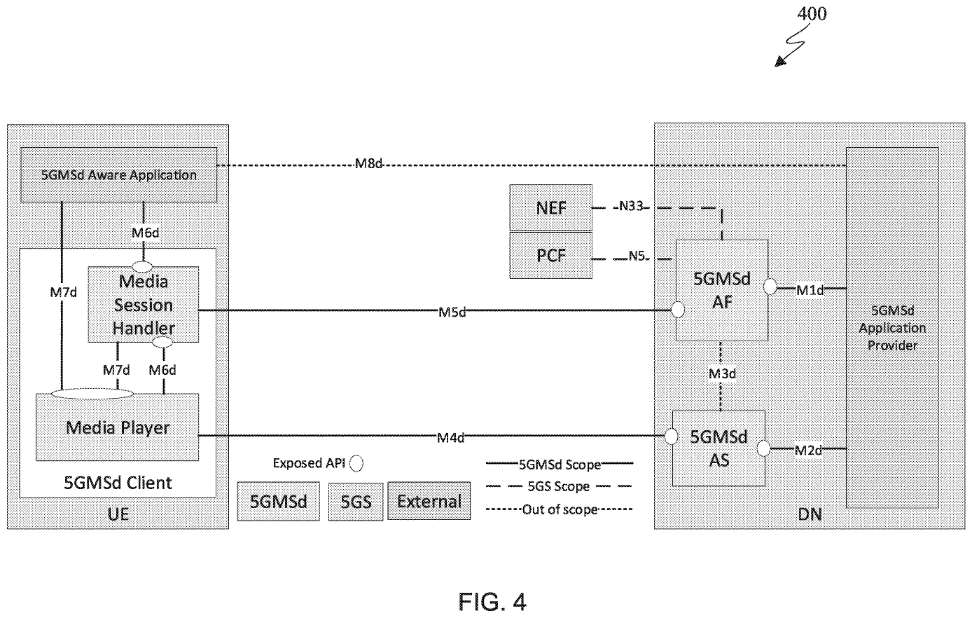

In various embodiments of the present disclosure, a communication system such as communications system 100 may be used to perform 5G Media Streaming (5GMS) based on the 5GMS architecture shown in FIG. 4.

FIG. 4 illustrates an example 5GMS architecture 400 according to embodiments of the present disclosure. The embodiment of a 5GMS architecture of FIG. 4 is for illustration only. Different embodiments of a 5GMS architecture could be used without departing from the scope of this disclosure.

In some embodiments, 5GMS architecture 400 may include one or more of the following components (some of which are not shown in FIG. 4):
5GMS AF: An Application Function dedicated to 5G Media Streaming. In the present disclosure, a 5GMS AF may also be referred to simply as an Application Function or AF. Any other generic Application Function may also be referred to herein as AF.
5GMS AS: An Application Server (AS) dedicated to 5G Media Streaming. In the present disclosure, a 5GMS AS may also be referred to simply as an Application Server or AS.
5GMS Client: A UE internal function dedicated to 5G Media Streaming. The 5GMS Client is a logical function and its sub-functions may be distributed within the UE according to implementation choice.
Media Stream Handler: A UE internal function that is part of the 5GMS Client and responsible for media stream handling functionality.
3GPP Access Node: An access network node in a 3GPP RAN (e.g., 4G LTE, 5G, NR, etc. base station such as base station 118).
Non-3GPP Access Node: An access network node that enables connectivity to a Non-3GPP access endpoint (such as wireless access point 120) to a 3GPP network (e.g., via a Non-3GPP Interworking Function [N3IWF] of a 3GPP network).
5GMS Application Provider: A service provider providing 5G media streaming services.
SMF: A Session Management Function in a 3GPP network.
UPF: A User Plane Function in 3GPP network.
5GMS ASP: An Application Service Provider (ASP) that provides 5G Media Streaming services to subscribed users using a 5GMS system. In the present disclosure, a 5GMS ASP may also be referred to simply as an Application Service Provider or ASP.

By utilizing 5GMS architecture 400, media services can be provisioned by an application service provider at a 5G AF using the M1 interface and content is ingested to a 5G AS using the M2 interface. After any processing to the ingested media (as provisioned by the application service provider and enforced by the 5G AF), the content is then distributed to end users using the M4 interface. The end user device UE uses the M5 and M4 interfaces to communicate back with the control and user plane functions (i.e., the 5G AF and 5G AS) in the core network.

Although FIG. 4 illustrates an example 5GMS architecture 400, various changes may be made to FIG. 4. For example, architecture 400 could include additional core network functions, etc. according to particular needs.

Network operators are deploying 5G advanced networks. One of the main use cases of 5G advanced networks is XRM (Extended Reality Media) services. XRM services augment traditional media services with new media types or realities (e.g., VR, AR, XR). XRM services have high network bandwidth and throughput requirements, and at the same time require high compute resources to generate, distribute, and consume XR media content. Players such as application service providers, content generators and network equipment vendors are investing heavily into evolution of service architectures to facilitate deployment of next generation services. With next generation services such as XRM, it has become imperative that design of next generation networks (5G, 5G-Advanced and beyond) is carried out keeping in view detailed application requirements.

External application service providers may provide XRM services to operator subscribers using capabilities of a 5G System. Network operator users and subscribers of the above application service provider may use XR terminal devices such as the Apple VisionPro™, Meta Oculus™ etc. to receive XR content over a 5G network, or via a Non-3GPP access network connected to the 5G network. Existing enablers of the 5G system allow for delivery of XR content with required QoS and reliability. Methods exist where the 5G system network functions expose XR service information to interested parties to assist in better managing those XR services. Application level constructs are being used to manage XR user plane traffic in 5G system between the UPF, NG-RAN, and the UE.

A number of enablers for extended reality media (XRM) are described in the 3^{rd} Generation Partnership Project's (3GPP)'s technical specifications (TSs) 3GPP TS 23.501 and TS 23.502, which relate to 5G System support for Extended Reality Media services. Among other things, these specifications describe:
Policy control enhancements to support multi-modality flows for single/multiple UEs: In this enabler, was added to the 5G system where multiple different types of flows of a single UE/multiple UEs (such as audio, video, sub-title, haptics etc.) that were necessary to be synchronized so the end users receive the true experience of the service were provided with the same type of QoS control using similar QoS configuration of those flows.
5G system information exposure for XR/media service: This enabler included two separate facilities as below. For both of these enablers, the motivation is for NG-RAN to inform the application layer endpoints (e.g., the UE and Application Server) of congestion information so that they may use application level constructs to initiate any rate adaptation logic to lessen the impact of a congested network.
   Explicit Congestion Marking for L4S (Low Latency, Low Loss, Scalable Throughput) traffic: In this enabler, an NG-RAN performs congestion identification in the system, and would mark the IP packets with such congestion information, and forwards them to UE (downlink) and/or UPF (uplink). Further the congestion information may be shared with UPF which can also then initiate the congestion marking in the IP layer packets, in both the uplink and downlink direction.
   Network information exposure to SMF/PCF/AF: In this enabler, NG-RAN nodes share information such as congestion information, QoS notification control, and data rate are shared with other network entities such as PCF, SMF, NEF, AF so they can influence upcoming application traffic into the network.
PDUSet based handling: In this enabler, support for QoS for a group of packets was added because application layer packets were usually transported as a group of lower layer IP packets, and thus these group of packets needed a singular mode of QoS control. To support this, the 5G system now can influence the QoS of a group of packets called a set of PDUs (PDUSet) through QoS configuration in the network. Parameters such as PDU Set information, including PDU Set Sequence Number, End PDU of the PDU Set, PDU Sequence Number within a PDU Set, PDU Set Size and PDU Set importance were added. Further PDU Set level QoS parameters such as PDU Set Delay Budget (PSDB) and PDU Set Error Rate (PSER) were introduced to control the delay and error rate on PDU Set level instead of PDU level
Uplink-downlink transmission coordination to meet round-trip latency requirements: In this enabler, support was added to indicate round-trip latency requirements by the application service providers, and the 5G system components would take responsibility to split the round-trip latency requirements to uplink latency requirements and downlink latency requirements based on network conditions, and configure the 5G system components to facilitate those requirements in both the directions.
Packet Delay Variation: In this enabler, the application service provider, and/or the PCF may be able to provide the packet delay variation between packets of application service to other 5G system components so they may be able to follow the variation in packet delays.
UE power savings based on network assistance information: In this enabler, 5G system network components may provide assistance information (e.g., periodicity and jitter) of application service packets to NG-RAN, so NG-RAN may perform some functionalities for power savings in the UE

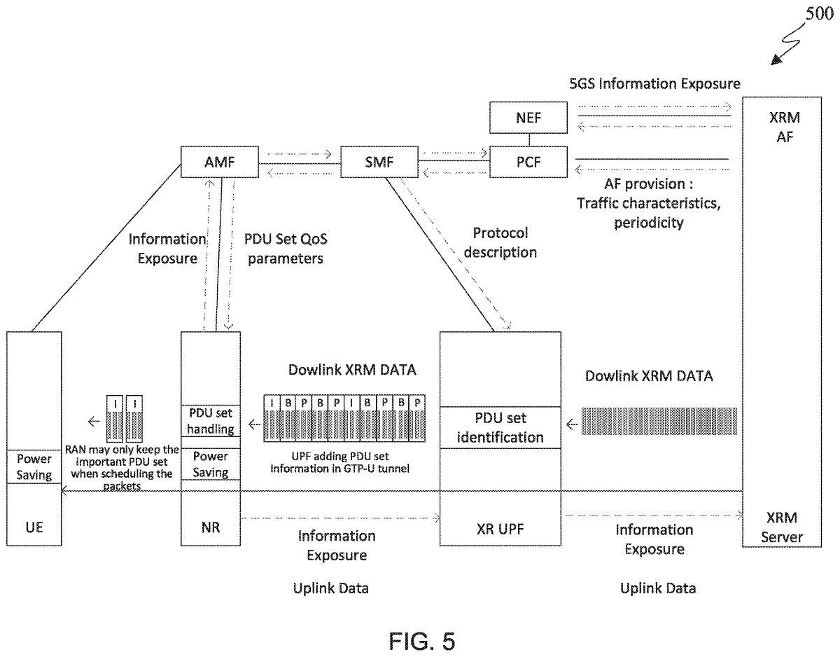

These various enablers are reflected in the architecture shown in FIG. 5.

FIG. 5 illustrates an example architecture for information exposure of XRM services 500 according to embodiments of the present disclosure. The embodiment of an architecture for information exposure of XRM services of FIG. 5 is for illustration only. Different embodiments of an architecture for information exposure of XRM services could be used without departing from the scope of this disclosure.

Although FIG. 5 illustrates one example an example architecture for information exposure of XRM services 500, various changes may be made to FIG. 5. For example, various changes to downlink XRM data could be made, etc., according to particular needs.

3GPP technical report (TR) 23700-70 also proposes a number of enablers for supporting XRM services in an operator network. Some of the enablers include:
Identifying whether the incoming packet is to be discarded because the NG-RAN has successfully delivered the required number of PDUs within a PDUSet using forward error correction (FEC) to the UE.
Sharing information about FEC coding from the Application Function in the network to the NG-RAN so that the NG-RAN may decide to discard some packets of a PDUSet.
Including information about a PDUSet in transport protocol headers such as Real-time Transport Protocol (RTP) and UDP (User Datagram Protocol), or in the encapsulation protocols such as GPRS Tunnelling Protocol (GTP), when the application packets are encrypted end-to-end. In this case, the network entities such as the UPF and NG-RAN use the transport layer headers to perform PDUSet management procedures similar as described in 3GPP TS 23.501 and 3GPP TS 23.502.
Traffic detection of XRM service traffic when the XRM traffic is encrypted.
Supporting Low Latency, Low Loss, Scalable Throughput (L4S) and congestion marking in Non-3GPP networks.
Alternative QoS profiles for a PDUSet if the currently configured QoS parameters of the PDUSet are unable to be satisfied.

Traditional media streaming services are delivered using technologies such as Motion Picture Experts Group (MPEG) Dynamic Adaptive Streaming over HTTP (DASH), HTTP Live Streaming (HLS), etc. Media applications (e.g., media players) on end user terminal devices interact with a streaming server to stream content over 5G network to the terminal devices. XR streaming services may be deployed in a similar manner, where the XR devices interact with external XR streaming servers to receive content. When the XR service traffic is delivered to the end user terminals, the application level characteristics information may be used by the 5G system entities to optimize delivery of XR media content. Various embodiments of the present disclosure provide mechanisms for managing PDUs of XR media service flows to assist with resource management in the radio and core network, as well as provide power savings for the operator network entities and UEs.

Traditional media services did not play an important role in developing cellular distribution systems. Frequently, media service traffic was either delivered over-the-air (OTT) on cellular networks (so media service traffic had no impact on the cellular network design) or with minimal network operator deployment assistance (e.g., for media content caching at the operator edge). However, due to the complexities involved in developing service architectures to facilitate delivery of next generation services such as XRM, it is required that detailed application level constructs such as traffic characteristics, service requirements are considered. Various embodiments of the present disclosure provide constructs for utilizing application traffic characteristics to adopt suitable resource allocation and power management schemes while delivering services such as XRM.

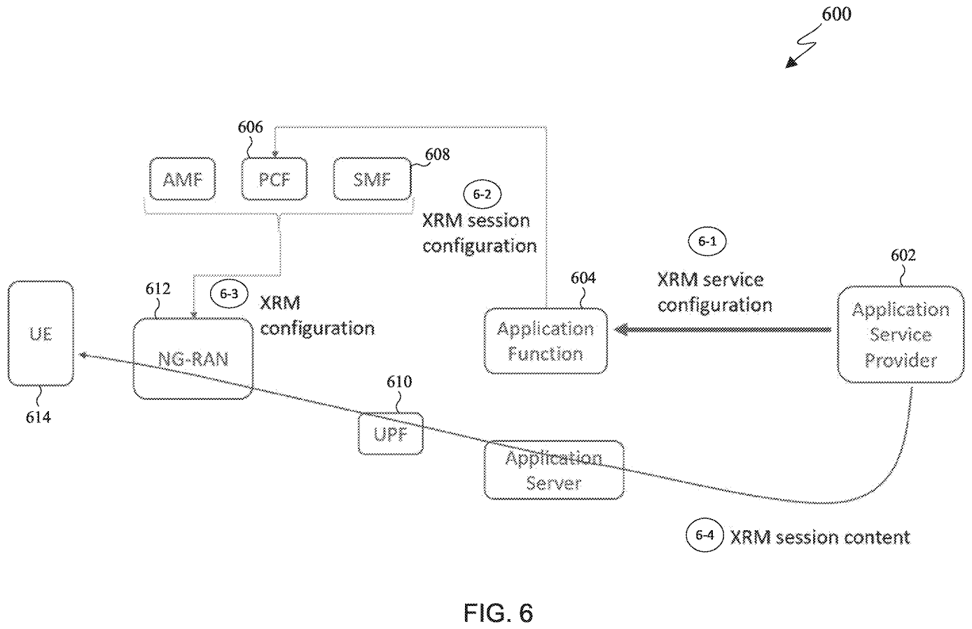

In some embodiments, an application service provider may provide an XRM service configuration information to an operator network (e.g., an NG-RAN). The XRM service information may then be shared with different network components within the operator network to aid with resource management while managing XR media traffic. For example, in some embodiments, such as shown in FIG. 6, an application service provider may configure XR service information at an Application Function inside the operator network similar as described in 3GPP TS 26.501 and TS 26.510. In embodiments such as these the XRM service configuration information may include any of the information from Table 1.

TABLE 1
XRM Service Configuration Information

| Information Element | Description |
|---|---|
| service_throughput | Expected service throughput required for delivery of XR |
| | media service |
| Initial_content_fetch_time | At the beginning of the service, amount of time the |
| | application service provider intends to push content as a |
| | burst into the operator network that is to be delivered to the |
| | UE |
| Initial_content_fetch_map | Map of content fetch times of different applications in |
| | different UEs. Each element in the map is a key, value pair |
| | where the key represents a unique Application Name or |
| | Application Identifier and the value represents the initial |
| | content fetch time for that application |
| | The Application names and/or Application Identifiers may |
| | be negotiated between the Application service provider and |
| | operator network. |
| min/avg/max | Minimum/Average/Maximum expected throughput in the |
| service_throughput_DL_content_fetch | downlink direction from the network to the UE for the |
| | XRM service during the pre-content fetch procedure |
| min/avg/max | Minimum/Average/Maximum expected throughput in the |
| service_throughput_UL_content_fetch | uplink direction from the UE to the network for the XRM |
| | service during the pre-content fetch procedure |
| min/avg/max | Minimum/Average/Maximum expected bandwidth to be |
| service_bandwidth_required_DL_content_fetch | provisioned by the operator in the downlink direction from |
| | the network to the UE for the XRM service during the pre- |
| | content fetch procedure |
| min/avg/max | Minimum/Average/Maximum expected bandwidth to be |
| service_bandwidth_required_UL_content_fetch | provisioned by the operator in the uplink direction from the |
| | UE to the network for the XRM service during the pre- |
| | content fetch procedure |
| min/avg/max | Minimum/Average/Maximum expected throughput in the |
| service_throughput_DL_post_content_fetch | downlink direction from the network to the UE for the |
| | XRM service after the pre-content fetch procedure |
| min/avg/max | Minimum/Average/Maximum expected throughput in the |
| service_throughput_UL_post_content_fetch | uplink direction from the UE to the network for the XRM |
| | service after the pre-content fetch procedure |
| min/avg/max | Minimum/Average/Maximum expected bandwidth to be |
| service_bandwidth_required_DL_post_content_fetch | provisioned by the operator in the downlink direction from |
| | the network to the UE for the XRM service after the pre- |
| | content fetch procedure |
| min/avg/max | Minimum/Average/Maximum expected bandwidth to be |
| service_bandwidth_required_UL_post_content_fetch | provisioned by the operator in the uplink direction from the |
| | UE to the network for the XRM service after the pre-content |
| | fetch procedure |
| suspend_for_savings | Boolean flag to indicate that the Application Service |
| | Provider intends that network operator undertake resource |
| | management and power management saving procedures |
| min/avg/max_catch_up_time | Amount of time expected to be elapsed before the UE |
| | requests for updated stream media components |

FIG. 6 illustrates an example procedure for XRM service configuration 600 according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for XRM service configuration could be used without departing from the scope of this disclosure.

In the example of FIG. 6, the procedure 600 begins at step 6-1. At step 6-1, an application service provider 602 is aware of traffic patterns of XRM content to be ingested into an operator network for consumption by operator network subscribers (e.g., UE 614). The application service provider 602 configures XRM service configuration information (for example, such as shown in Table 1) at an application function (AF) 604 in the operator network.

At step 6-2, when the AF 604 receives the XRM service configuration information, the AF 604 parses the request and performs session QoS for the service (e.g., similar as described in 3GPP TS 23.501 and TS 23.502). For example, the AF 604 may request a PCF 606 to apply policy to the media streams of the XR stream in both the downlink and uplink direction. The AF 604 may provide traffic identification information to identify the QoS Flows of the XRM service.

At step 6-3, the network components (e.g., the PCF 606) may generate updated QoS policies and share them with the SMF 068, which in turn may share the policy information for the XRM traffic at a UPF 610 and an NG-RAN 612.

At step 6-4, after the XRM service provisioning, the application service provider 602 may ingest XRM service content into the operator network. The operator network functions such as UPF 610 and NG-RAN 612 may perform the policies and procedures configured by the PCF 606 via the SMF 608.

Although FIG. 6 illustrates one example procedure for XRM service configuration 600, various changes may be made to FIG. 6. For example, while shown as a series of steps, various steps in FIG. 6 could overlap, occur in parallel, occur in a different order, occur any number of times, be omitted, or replaced by other steps.

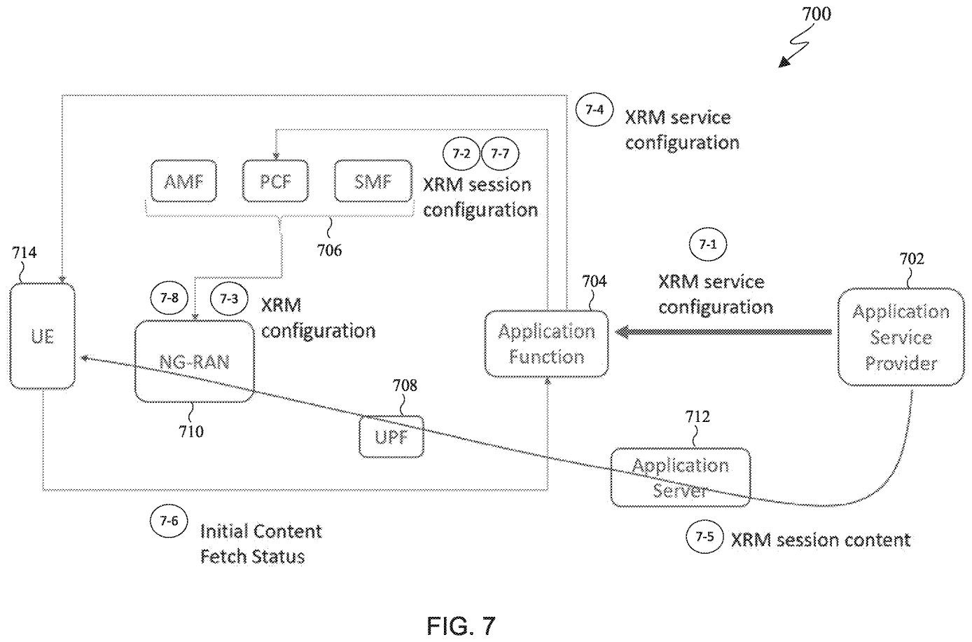

When a UE runs some of the existing streaming applications such as YouTube, the UE, upon start of a session, can fetch some content that can be stored in the UE application buffer before the content gets played to the end user. Different streaming applications may use different amounts of time the content gets buffered before the content starts playing on the UE application player to the end user. To facilitate this procedure, it would be useful for the network to provide functionality for configuration and provisioning of the initial content fetch time similar as shown in FIG. 7, because the data requesting behavior of the UE during the time of the initial content fetch is different than the data requesting behavior of the UE during the period after fetching the initial content.

FIG. 7 illustrates an example procedure for XRM service configuration for initial content fetch 700 according to embodiments of the present disclosure. An embodiment of the procedure illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of a procedure for XRM Service configuration for Initial Content Fetch could be used without departing from the scope of this disclosure.

In the example of FIG. 7, the procedure 700 begins at step 7-1. At step 7-1, an application service provider 702 is aware of an amount of initial_content_fetch times for different applications operating on different UEs in an operator network. If the application service provider 702 only supports a single application for XRM delivery, the service configuration information element “Initial_content_fetch_time” is configured. Alternatively, if the Application service provider supports multiple XRM applications, it may provide a map “Initial_content_fetch map” with mapping information of Application Name/Application Identifier to the corresponding initial content fetch time for that application. In addition to the content fetch time, the application service provider may also configure the “min/avg/max service_throughput_DL_content_fetch”, “min/avg/max service_throughput_UL_content_fetch”, “min/avg/max service_bandwidth_required_DL_content_fetch”, “min/avg/max service_bandwidth_required_UL_content_fetch”, “min/avg/max service_throughput_DL_post_content_fetch”, “min/avg/max service_throughput_UL_post_content_fetch”, “min/avg/max service_bandwidth_required_DL_post_content_fetch”, “min/avg/max service_bandwidth_required_UL_post_content_fetch” parameters described earlier in the Table 1.

At step 7-2, an AF 704 may perform XRM session configuration with operator network functions 706 to configure the initial content fetch time for one or more UE applications (i.e., of UE 714) similar as described herein.

At step 7-3, the operator network functions 706 configure 5G system components such as the UPF 708, and NG-RAN 710 as described herein to inform them of the initial content fetch time, and the throughput and bandwidth information provided by the “min/avg/max service_throughput_DL_content_fetch”, “min/avg/max service_throughput_UL_content_fetch”, “min/avg/max service_bandwidth_required_DL_content_fetch”, “min/avg/max service_bandwidth_required_UL_content_fetch” parameters. Based on the received information, NG-RAN 710 may provide enough radio resources to satisfy the throughput and bandwidth requirements in both the uplink and downlink direction to allow the UEs (such as UE 714) to download the initial content fetch as below:
If the “min/avg/max service_throughput_DL_content_fetch” parameter is configured, NG-RAN 710 may setup the radio resources in downlink direction to allow the given throughput requirements.
If the “min/avg/max service_bandwidth_required_DL_content_fetch” parameter is configured, NG-RAN 712 may setup the radio resources in downlink direction to allow the given bandwidth requirements.
If the “min/avg/max service_throughput_UL_content_fetch” parameter is configured, NG-RAN 712 may setup the radio resources in the uplink direction to allow the given throughput requirements for the XRM service
If the “min/avg/max service_bandwidth_required_UL_content_fetch” parameter is configured, NG-RAN 712 may setup the radio resources in the uplink direction to allow the given bandwidth requirements.

At step 7-4, the UE application (i.e., of UE 714) may retrieve the XRM service configuration information from the Application Function 704 (e.g., using the M5 interface similar as specified in 3GPP TS 26.501 and TS 26.510).

At step 7-5, the UE 714 receives XRM media content from the application server 712. Since enough radio bearer resources were setup in Step 7-3 above, the initial XRM content is delivered to the UE 714.

At step 7-6, the UE 714 and/or the application of the UE 714 informs the Application Function 704 that the UE 714 is done with initial content fetch, and enough content is buffered in the UE 714 application buffer. To provide this information, the UE 714 and/or the UE 714 application may use the M5 interface, similar as specified in 3GPP TS 26.501 and TS 265.10.

At step 7-7, the Application Function 704 may perform an update of the XRM service configuration at the network operator functions 706 to indicate that the initial content fetch is complete, and that the user may not need the allocated radio resources in NG-RAN 710. The Application Function 704 may then inform the network operator network functions 706 to reduce the radio resources for the continuation of XRM service to the end users.
In some embodiments, if the “min/avg/max service_throughput_DL_post_content_fetch” parameter is configured by the application service provider 702, the Application Function 704 may inform the network operators 706 to reduce the allocated radio resources to accommodate the updated throughput in downlink direction
In some embodiments, if the “min/avg/max service_throughput_UL_post_content_fetch” parameter is configured by the application service provider 702, the Application Function 704 may inform the network operators to reduce the allocated radio resources to accommodate the updated throughput in uplink direction
In some embodiments, if the “min/avg/max service_bandwidth_required_DL_post_content_fetch” parameter is configured by the application service provider 702, the Application Function 704 may inform the network operators to reduce the allocated radio resources to accommodate the updated bandwidth requirement in downlink direction
In some embodiments. If the “min/avg/max service_bandwidth_required_UL_post_content_fetch” parameter is configured by the application service provider, the Application Function 104 may inform the network operators to reduce the allocated radio resources to accommodate the updated bandwidth requirement in the uplink direction

At step 7-8, Based on the new throughput and bandwidth requirements from the Application Function 704 for fetching content post initial content, the network operator network functions may perform an XRM configuration update at UPF 708 and/or NG-RAN 710 to facilitate setup/teardown of radio resources of the XRM service.

Although FIG. 7 illustrates one example procedure for XRM Service configuration for Initial Content Fetch 700, various changes may be made to FIG. 7. For example, while shown as a series of steps, various steps in FIG. 7 could overlap, occur in parallel, occur in a different order, occur any number of times, be omitted, or replaced by other steps.

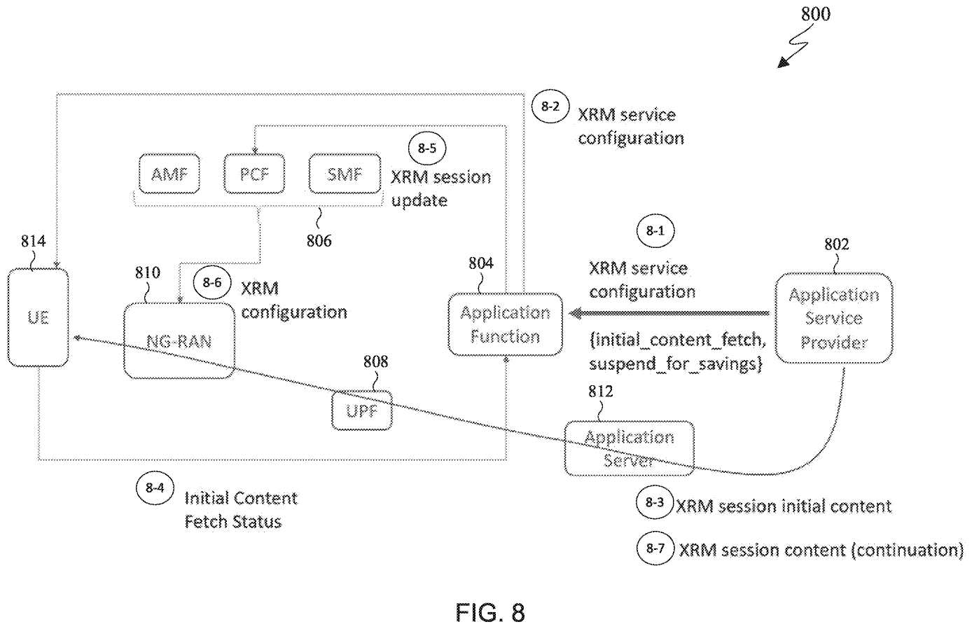

In some embodiments, radio resource savings in an NG-RAN and/or power savings in the network and/or the UE during XRM delivery procedures may be configured similar as shown in FIG. 8.

FIG. 8 illustrates an example procedure for XRM Service configuration for radio resource and power savings 800 according to embodiments of the present disclosure. An embodiment of the procedure illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a procedure for XRM Service configuration for radio resource and power savings could be used without departing from the scope of this disclosure.

In the example of FIG. 8, the procedure 800 begins at step 8-1. At step 8-1, an application service provider 802 is aware of an amount of initial_content_fetch times for different applications on different UEs (such as UE 814) in the operator network and configures those parameters similar as described herein. Along with the initial content fetch time, the application service provider may also enable a “suspend_for_savings” boolean flag in the service configuration information.

At step 8-2 the UE application (i.e., of UE 814) may retrieve the XRM service configuration information from the Application Function 804 (for example, using the M5 interface specified in 3GPP TS 26.501 and TS 26.510).

At step 8-3 the UE 814 receives XRM media content from the application server 812. Since enough radio bearer resources were setup in step 8-2, the initial XRM content is delivered to the UE.

At step 8-4 the UE 814 and/or the application of the UE 814 informs the Application Function 804 that it is done with initial content fetch, and enough content is buffered in the UE 814 application buffer. To provide this information, the UE 814 and/or the UE 814 application may use the M5 interface, similar as specified in 3GPP TS 26.501 and TS 26.510.

At step 8-5 the Application Function 804 may perform an update of the XRM service configuration at the network operator functions 806 to indicate that the initial content fetch is complete, and it may be some time before radio resources are necessary to transmit XRM content to the end user. The Application Function may recommend the network operator functions such as NG-RAN to suspend radio resources allocated to the UE 814.

At step 8-6, based on the above information from the Application Function 804, the network operator functions 806 may suspend radio resources allocated to the UE 814 by requesting NG-RAN 810 and UPF 808 to initiate such procedures. When the NG-RAN receives this information, the network operation functions 806 may suspend the radio resources allocated to the UE 814. Alternatively, the NG-RAN 810 may initiate power saving schemes (e.g., similar described in 3GPP TS 23.501 and TR23700-70). Optionally, the network operator functions 806 may also include a flag called “activate-upon-new-media” to signal to NG-RAN 810 that if it sees new media content for this service, then it is to re-activate the radio resources or stop the power saving schemes.

At step 8-7, after some time, when the new media content of XRM service reaches the NG-RAN 810 (e.g., when a new PDUSet is received by NG-RAN 810), the NG-RAN 810 may reactivate the radio resources so the UE 814 continues to receive new media content for the XRM service.

Although FIG. 8 illustrates one example procedure for XRM Service configuration for radio resource and power savings 800, various changes may be made to FIG. 8. For example, while shown as a series of steps, various steps in FIG. 8 could overlap, occur in parallel, occur in a different order, occur any number of times, be omitted, or replaced by other steps.

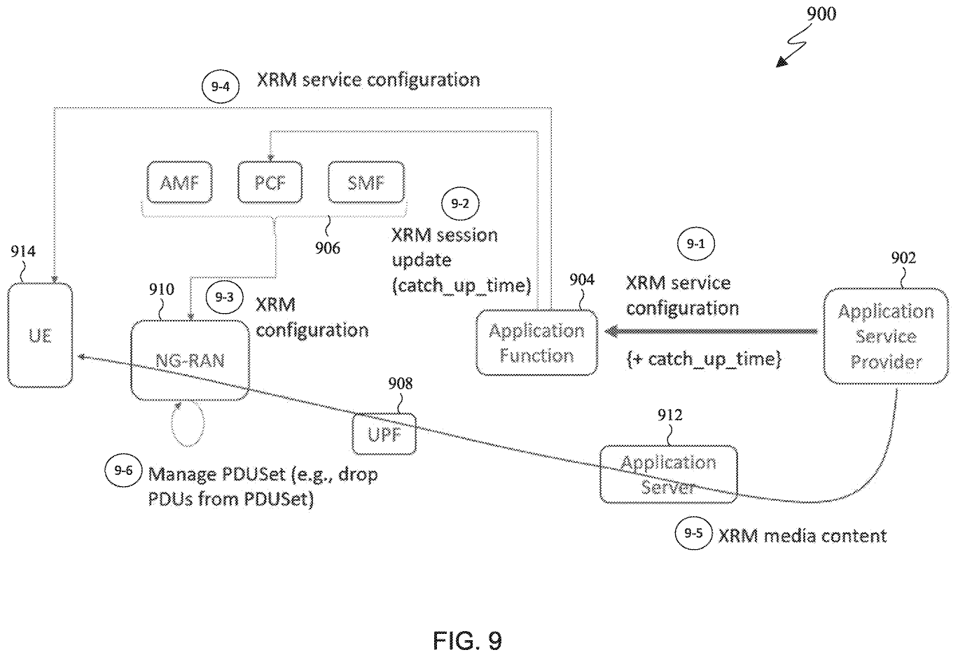

In Adaptive Bit Rate (ABR) streaming of media content (e.g., XR media content), a media player may request a higher adaptation/representation when the media player sees that the available bandwidth has increased, or may request a lower adaptation/representation when the media player sees that the available bandwidth has decreased. This is the design behind ABR streaming, and standardized in technologies such as MPEG DASH and Apple HLS. Some ABR media content players, after noticing an increase or decrease in available bandwidth, do not instantly request for new bandwidth/throughput, but wait for certain amount of time before requesting the new adaptation/representation. This behavior of the ABR media players can be taken into consideration to help with management of PDUSets in a 5G core network and NG-RAN, similar as shown in FIG. 9.

FIG. 9 illustrates an example procedure for Managing PDUs in an NG-RAN based on UE application adaptation 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for Managing PDUs in an NG-RAN based on UE Application Adaptation could be used without departing from the scope of this disclosure.

In the example of FIG. 9, the procedure 900 begins at step 9-1. At step 9-1, an application service provider 902 configures XRM service configuration information at the Application Function 904 in the operator network similar as described herein. As part of the service configuration information, the application service provider 902 includes the min/max/avg catch_up_time for the XR media content. Alternatively, in some embodiments, the application service provider 902 may configure a separate min/max/avg catch_up_time for each flow in the XR media service. The catch_up_time represents the amount of time the UE application (e.g., of UE 914) waits before it requests for new adaptation/representation. In some embodiments, The XR service configuration may occur based on the service configuration procedure specified in 3GPP TS 26.501 and TS 26.510.

At step 9-2, when the Application Function 904 receives the XRM service configuration information, it parses the request and performs session QoS for the service as described herein. As part of this session configuration, the Application Function 904 may inform the 5G system network functions 906 about the above configured catch_up_time information for the service, or for each individual flow in the XR media service.

At step 9-3 the network components 906 (e.g., the PCF) may generate updated QoS policies (e.g., PDUSet QoS parameters similar as specified in 3GPP TS 23.501 and TS 23.502) and share them with the other network components 906 (e.g., the SMF), which in turn may share the policy information at the UPF 908 and NG-RAN 910 for the XRM traffic. As part of this configuration, the NG-RAN 910 and/or UPF 908 may be informed of the UE application (i.e., of UE 914) catch_up_time.

At step 9-4, the UE application (i.e., of UE 914) may retrieve the XR media service configuration information from the Application Function 904 (for example, using the ServiceAccessConfiguration procedure specified in 3GPPP TS 26.501 and TS 26.510).

At step 9-5, after the XRM service provisioning, the Application Service Provider 802 may ingest XRM service content into the operator network. Application PDUSets may be transmitted between the Application Server 912 and the UE 914. The operator network functions such as UPF 908 and NG-RAN 910 may perform the policies and procedures configured by the network components 906 (e.g., the PCF via the SMF) on the above PDUSet traffic.

Sometime later, at step 9-6, when the operator network functions 906 and/or NG-RAN 910 see a change in network performance (e.g., the network performance has gone down), the operator network functions 906 and/or NG-RAN 910 know that the UE application (i.e., of UE 914) is going to shortly request for lower quality representations. At this stage, if the NG-RAN 910 sees that it is currently in the middle of transporting PDUs of a PDUSet, the NG-RAN 912 may decide to drop the remaining PDUs as the UE 914 is going to request for PDUs with lower quality representation. Alternatively, if the network performance has increased, the NG-RAN 910 may perform dropping of PDUs in PDUSet delivering current quality as it expects the UE 914 to request higher quality representations/adaptations.

In some embodiments, the operator network functions 906 and/or NG-RAN 910 may actually delay the process of dropping of PDUs in PDUSet of current quality based on the configured catch_up_time configuration information it received from other operator network functions. This delay time may be equal to the configured catch_up_time, or a fraction of the catch_up_time where the fraction is a scalar value that is configured by the 5G System components. In some applications, the fraction scalar can also be configured by the application service provider 902 for the XR media service.

Although FIG. 9 illustrates one example procedure for Managing PDUs in an NG-RAN based on UE Application Adaptation 900, various changes may be made to FIG. 9. For example, while shown as a series of steps, various steps in FIG. 9 could overlap, occur in parallel, occur in a different order, occur any number of times, be omitted, or replaced by other steps.

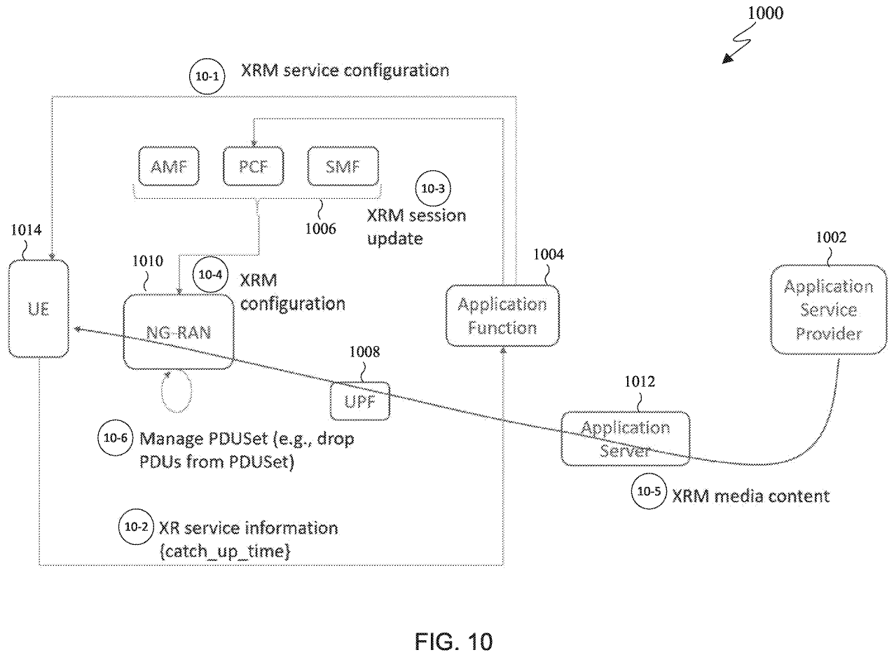

In the embodiment of FIG. 9, network adaptation of PDUSet delivery is based on configuration information from the Application service provider to operator network functions. In an alternative embodiment, it is possible that information such as catch up time to request for new adaptation/representation may be provided by the UE to operator network functions and/or NG-RAN, similar as shown in FIG. 10.

FIG. 10 illustrates an example procedure for managing PDUs in an NG-RAN based on UE application adaptation feedback 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for managing PDUs in an NG-RAN based on UE application adaptation feedback could be used without departing from the scope of this disclosure.

In the example of FIG. 10, it is assumed that an XR media streaming service is configured by the application service provider 1002 at the Application Function 1004, and the Application Function 1004 has informed the network operator of the XR session configuration information. Further, the network operator functions 1106 have provided QoS policies including PDUSet QoS parameters (for example, similar as specified in 3GPP TS 23.501) to NG-RAN 1010 and/or UPF 1008, similar as described herein.

The procedure 1000 begins at step 10-1. At step 10-1, a UE application (i.e., of UE 1014) may retrieve the XR media service configuration information from the Application Function 1004 (e.g., using the ServiceAccessConfiguration procedure similar as specified in 3GPP TS 26.501 and TS 26.510).

At step 10-2 based on the service configuration information (e.g., types of available adaptations/representations, media types, codec type etc.), the UE 1014 knows the sizes of application buffers, and therefore may have information about catch_up_time for XR media service, and/or for each of the XR media service flows. The UE 1014 may provide such catch_up_time information to the Application Function 1004 (for example using the M5 interface similar as specified in 3GPP TS 26.501 and TS 26.510).

At step 10-3, the Application Function 1004, may share the catch_up_time information it receives from the UE 1014 to the network operator functions 1006 similar as described herein by performing an XR session update procedure.

At step 10-4, the network components 1006 (e.g., the PCF) may generate updated QoS policies (e.g., PDUSet QoS parameters similar specified in 3GPP TS 23.501 and TS 23.502) and share them with the SMF, which in turn may share the policy information at the UPF 1008 and NG-RAN 1010 for the XRM traffic. As part of this configuration, the NG-RAN 1010 and/or UPF 1008 may be informed of the UE application catch_up_time.

At step 10-5, the application service provider 1002 ingests XRM service content into the operator network. Application PDUSets may be transmitted between the Application Server 1012 and the UE 1014. The operator network functions such as UPF 1008 and NG-RAN 1010 may perform the policies and procedures configured by network components 1006 (i.e., the PCF via the SMF) on the above PDUSet traffic.

Sometime later, at step 10-6, when the operator network functions 1006 and/or NG-RAN 1010 see a change in network performance (e.g., network performance has gone down), the operator network functions 1006 and/or NG-RAN 1010 know that the UE application is going to shortly request for lower quality representations. At this stage, if the NG-RAN 1010 sees that it is currently in the middle of transporting PDUs of a PDUSet, the NG-RAN 1010 may decide to drop the remaining PDUs as the UE 1014 is going to request for PDUs with lower quality representation. Alternatively, if the network performance has increased, the NG-RAN 1010 may perform dropping of PDUs in the PDUSet delivering the current quality as it expects the UE 1014 to request higher quality representations/adaptations.

In some embodiments the operator network functions 1006 and/or NG-RAN 1010 may actually delay the process of dropping of PDUs in the PDUSet of current quality based on the configured catch_up_time configuration information it received from other operator network functions. The UE application includes this catch_up_time information in an RTP header and sends it to UPF 1008. The UPF 1008 may run a RTP proxy, in which case it may read the catch_up_time information. The UPF 1008 may in-turn share this information with NG-RAN 1010 and/or other 5G System network functions 1006. In some embodiments, the fraction scalar can also be configured by the application service provider 1002 for the XR media service.

Although FIG. 10 illustrates one example procedure for managing PDUs in an NG-RAN based on UE application adaptation feedback 1000, various changes may be made to FIG. 10. For example, while shown as a series of steps, various steps in FIG. 10 could overlap, occur in parallel, occur in a different order, occur any number of times, be omitted, or replaced by other steps.

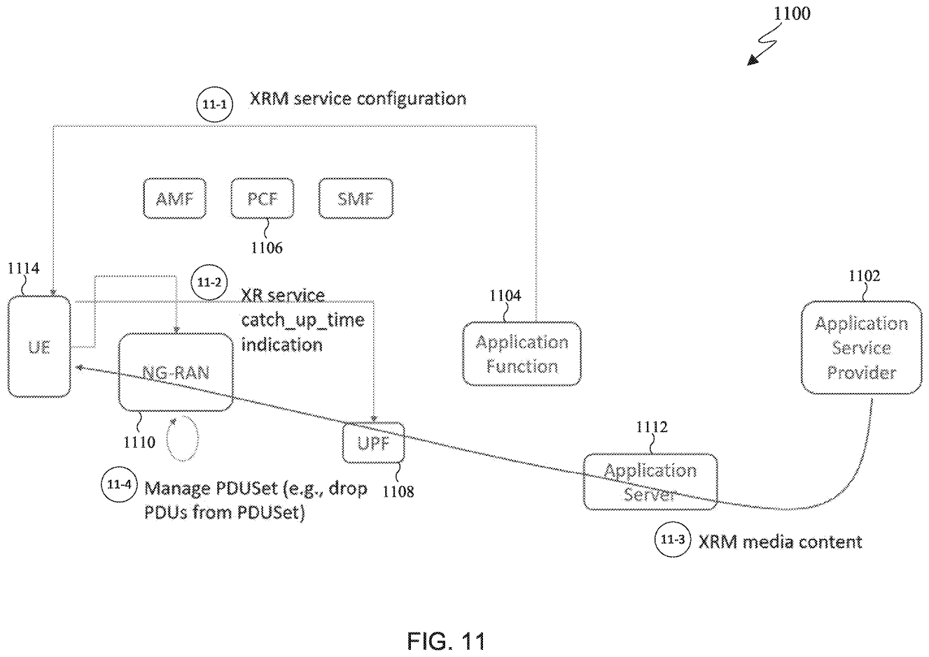

In the embodiment of FIG. 10, network adaptation of PDUSet delivery is based on UE feedback at the application layer. In some embodiments, a similar procedure may use the services of the network and physical layer, similar as shown in FIG. 11.

FIG. 11 illustrates an example procedure for managing PDUs in an NG-RAN based on UE application adaptation feedback at the network/physical layer 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for managing PDUs in an NG-RAN based on UE application adaptation feedback at the network/physical layer could be used without departing from the scope of this disclosure.

In the example of FIG. 11, It is assumed that an XR media streaming service is configured by the application service provider 1102 at the Application Function 1104, and the Application Function 1104 has informed the network operator of XR session configuration information. Further, the network operator functions 1106 have provided QoS policies including PDUSet QoS parameters (for example, similar as specified in 3GPP TS 23.501) to NG-RAN 1110 and/or UPF 1108, similar as described herein.

The procedure 1100 begins at step 11-1. At step 11-1, a UE application (i.e., of UE 1114) may retrieve the XR media service configuration information from the Application Function 1104 (e.g., using the ServiceAccessConfiguration procedure similar as specified in 3GPP TS 26.501 and TS 26.510).

At step 11-2, based on the service configuration information (e.g., types of available adaptations/representations, media types, codec type etc.), the UE 1114 knows the sizes of application buffers, and therefore may have information about catch_up_time for the XR media service, and/or for each of the XR media service flows. The UE 1114 may provide the catch_up_time information to the following entities:
a. To the NG-RAN 1110, for example using the outbound GTP packet header. The NG-RAN 1110, may in-turn forward this information to the UPF 1108 and/or other 5G System network functions 1106.
b. To the UPF 1108, for example using UDP Options inside the UDP header. The UE application includes this catch_up_time information in UDP header and sends it to UPF 1108. The UPF 1108 may run a UDP proxy, in which case it may read the catch_up_time information. The UPF 1108 may in-turn share this information with NG-RAN 1110 and/or other 5G System network functions 1106.
c. To the UPF 1108, for example using RTP Header Extensions. The UE application includes this catch_up_time information in RTP header and send it to UPF 1108. The UPF 1108 may run a RTP proxy, in which case it may read the catch_up_time information. The UPF 1108 may in-turn share this information with NG-RAN 1110 and/or other 5G System network functions 1106.
d. To the UPF 1108, for example using QUIC protocol headers. The UE application includes this catch_up_time information in QUIC header and send it to UPF 1108. The UPF 1108 may run a QUIC proxy, in which case it may read the catch_up_time information. The UPF 1108 may in-turn share this information with NG-RAN 1110 and/or other 5G System network functions 1106.

In all the above cases, the operator network functions may infer updated QoS policies and share them with NG-RAN 1110 and/or UPF 1108 (e.g., using existing procedures similar as specified in 3GPP TS 23.501 and TS 23.502).

At step 11-3, the application service provider 1102 ingests XRM service content into the operator network. Application PDUSets may be transmitted between the Application Server 1112 and the UE 1114. The operator network functions such as UPF 1108 and NG-RAN 1110 may perform the policies and procedures configured by network components 1106 (i.e., the PCF via the SMF) on the above PDUSet traffic.

Sometime later, at step 11-4, when the operator network functions 1106 and/or NG-RAN 1110 see a change in network performance (e.g., the network performance has gone down), the operator network functions 1106 and/or NG-RAN 1110 know that the UE application is going to shortly request for lower quality representations. At this stage, if the NG-RAN 1110 sees that it is currently in the middle of transporting PDUs of a PDUSet, the NG-RAN 1110 may decide to drop the remaining PDUs as the UE 1114 is going to request for PDUs with lower quality representation. Alternatively, if the network performance has increased, the NG-RAN 1110 may perform dropping of PDUs in the PDUSet delivering the current quality as it expects the UE 1114 to request higher quality representations/adaptations.

In some embodiments, the operator network functions 1106 and/or NG-RAN 1110 may actually delay the process of dropping of PDUs in a PDUSet of current quality based on the configured catch_up_time configuration information it received from other operator network functions. This delay time may be equal to the configured catch_up_time, or a fraction of the catch_up_time where the fraction is a scalar value that is configured by the 5G System components. In some embodiments, the fraction scalar can also be configured by the application service provider 11102 for the XR media service.

Although FIG. 11 illustrates one example procedure for managing PDUs in an NG-RAN based on UE application adaptation feedback at the network/physical layer 1100, various changes may be made to FIG. 11. For example, while shown as a series of steps, various steps in FIG. 11 could overlap, occur in parallel, occur in a different order, occur any number of times, be omitted, or replaced by other steps.

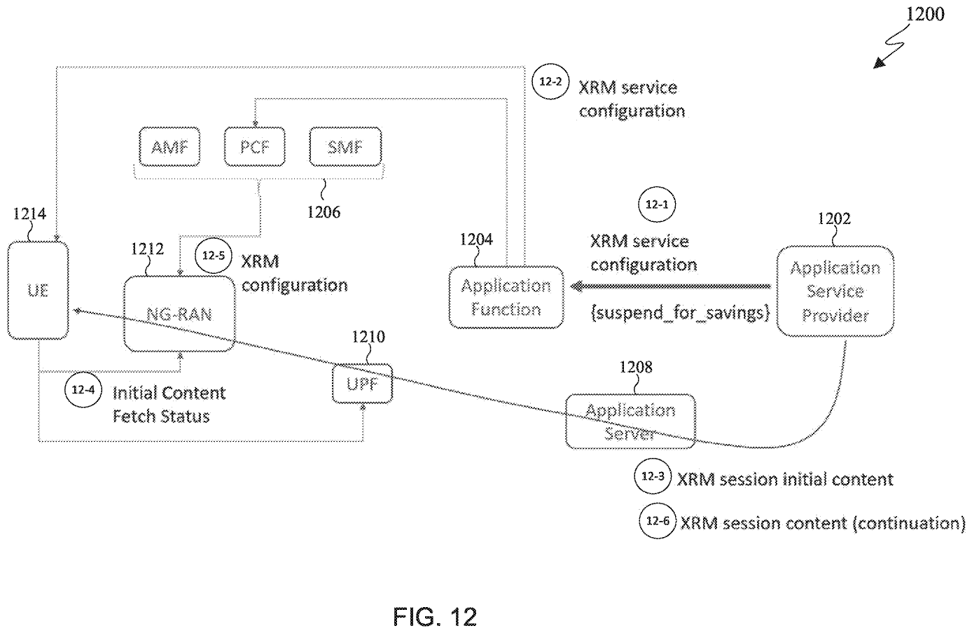

The embodiment of FIG. 11 is a procedure for saving radio resources in NG-RAN and/or power savings in the network and/or the UE during XRM delivery procedures. In FIG. 12, an embodiment of a similar procedure is shown, but the UE feedback is delivered via network/physical layer signaling.

FIG. 12 illustrates an example procedure for radio resource and power savings based on feedback from a UE 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for radio resource and power savings based on feedback from a UE could be used without departing from the scope of this disclosure.

In the example of FIG. 12, the procedure 1200 begins at step 12-1. At step 12-1, an application service provider 1202, may enable a “suspend_for_savings” boolean flag in the service configuration information similar as described herein.

At step 12-2 a UE application (i.e., of UE 1214) may retrieve the XRM service configuration information from the Application Function 1204 (for example, using the M5 interface similar specified in 3GPP TS 26.501 and TS 26.510).

At step 12-3, the UE 1214 receives XRM media content from the application server 1208. Since enough radio bearer resources were setup in Step 12-2, the initial XRM content is delivered to the UE 1214.

At step 12-4, the UE 1214 and/or the application of the UE 1214 informs the following entities that it is done with initial content fetch, and enough content is buffered in the UE application buffer.
To the NG-RAN 1210, for example using the outbound GTP packet header. The NG-RAN 1210, may in-turn forward this information to the UPF 1208 and/or other 5G System network functions 1206.
To the UPF 1208, for example using UDP Options inside the UDP header. The UE application includes this catch_up_time information in UDP header and send it to UPF 1208. The UPF 1208 may run a UDP proxy, in which case it may read the catch_up_time information. The UPF may in-turn share this information with NG-RAN and/or other 5G System network functions 1206.
To the UPF 1208, for example using RTP Header Extensions. The UE application includes this catch_up_time information in RTP header and send it to UPF 1208. The UPF 1208 may run a RTP proxy, in which case it may read the catch_up_time information. The UPF 1208 may in-turn share this information with NG-RAN 1210 and/or other 5G System network functions 1206.
To the UPF 1208, for example using QUIC protocol headers. The UE application includes this catch_up_time information in QUIC header and send it to UPF 1208. The UPF 1208 may run a QUIC proxy, in which case it may read the catch_up_time information. The UPF 1208 may in-turn share this information with NG-RAN 1210 and/or other 5G System network functions 1206.

At step 12-5, based on the above information from NG-RAN 1210 and/or UPF 1208, the network operator functions 1206 may suspend radio resources allocated to the UE 1214 by requesting NG-RAN 1210 and UPF 1208 to initiate such procedures. When the NG-RAN 1210 receives this information, it may suspend the radio resources allocated to the UE 1214. Alternatively, the NG-RAN 1214 may initiate power saving schemes (for example, similar as described in 3GPP TS 23501 and TR 23700-70). Optionally, the network operator functions 1206 may also include a flag called “activate-upon-new-media” to signal to the NG-RAN 1214 that if it sees new media content for this service, then it is to re-activate the radio resources or stop the power saving schemes.

After some time, at step 12-6, when the new media content of XRM service reaches the NG-RAN 1210 (e.g., when a new PDUSet is received by NG-RAN 1210), the NG-RAN 1210 may reactivate the radio resources, so the UE 1214 continues to receive new media content for the XRM service.

Although FIG. 12 illustrates one example procedure for radio resource and power savings based on feedback from a UE 1200, various changes may be made to FIG. 12. For example, while shown as a series of steps, various steps in FIG. 12 could overlap, occur in parallel, occur in a different order, occur any number of times, be omitted, or replaced by other steps.

In some embodiments, procedures for XRM service configuration from the application service provider to the operator network as described herein can be extended by including the information in Table 2. This information can then share to different network components in a network (such as a 5G network) to help with resource management (for example, in an NG-RAN) while managing XR media traffic.

TABLE 2
Additional XRM Service Configuration Information

| Information Element | Description |
|---|---|
| min/avg/max | Minimum/Average/Maximum aggregate throughput in the |
| service_aggregate_throughput_DL | downlink direction from the network to the UE for the |
| | XRM service during and post the pre-content fetch |
| | procedure |
| min/avg/max | Minimum/Average/Maximum aggregate throughput in the |
| service_aggregate_throughput_UL | uplink direction from the UE to the network for the XRM |
| | service during and post the pre-content fetch procedure |
| min/avg/max | Minimum/Average/Maximum aggregate throughput in the |
| service_aggregate_bandwdth_required_DL | downlink direction from the network to the UE for the |
| | XRM service during and post the pre-content fetch |
| | procedure |
| min/avg/max | Minimum/Average/Maximum aggregate throughput in the |
| service_aggregate_bandwidth_required_UL | uplink direction from the UE to the network for the XRM |
| | service during and post the pre-content fetch procedure |
| burst_periodicity_post_initial_content_fetch | Periodicity of burst post initial content fetch procedure |
| burst_sample | Number of samples to infer the burst_interval below |
| burst_interval or burst_size | Time period for each burst |
| | Average burst interval may be configured by the |
| | Application service provider |
| | Alternately, the maximum and minimum burst interval |
| | among the last “burst_sample” number of bursts may be |
| | configured by the Application service provider |
| min/avg/max service_burst_bandwdth_required_DL | Minimum/Average/Maximum bandwith required in the |
| | downlink direction from the network to the UE for the |
| | XRM service during the burst interval |
| min/avg/max service_burst_bandwidth_required_UL | Minimum/Average/Maximum bandwith required in the |
| | uplink direction from the network to the UE for the XRM |
| | service during the burst interval |
| min/avg/max | Minimum/Average/Maximum expected bandwidth to be |
| service_bandwidth_required_fallback_DL | provisioned by the operator in the downlink direction from |
| | the network to the UE for the XRM service after the pre- |
| | content fetch procedure in case the UE falls back to a |
| | different quality stream |
| min/avg/max | Minimum/Average/Maximum expected bandwidth to be |
| service_bandwidth_required_fallback_UL | provisioned by the operator in the uplink direction from the |
| | UE to the network for the XRM service after the pre-content |
| | fetch procedure in case the UE falls back to a different |
| | quality stream |

Some embodiments described herein provide procedures for XRM service configuration where downlink and uplink throughput and required bandwidth values a configured/provisioned separately for initial content fetch and for post initial content fetch. Alternatively, in some embodiments, instead of configuring/provisioning separate values, the Application service provider may only configure aggregate values. In embodiments such as these, the Application service provider may configure the following parameters (for example using the M1 interface similar as specified in 3GPP TS 26.501 and TS 26.510) described previously herein:
min/avg/max service_aggregate_throughput_DL
min/avg/max service_aggregate_throughput_UL
min/avg/max service_aggregate_bandwdth_required_DL
min/avg/max service_aggregate_bandwidth_required_UL

In some embodiments, in addition to the above throughput and bandwidth required parameters, the application service provider may also separately configure bit rate requirements in the downlink and uplink direction.

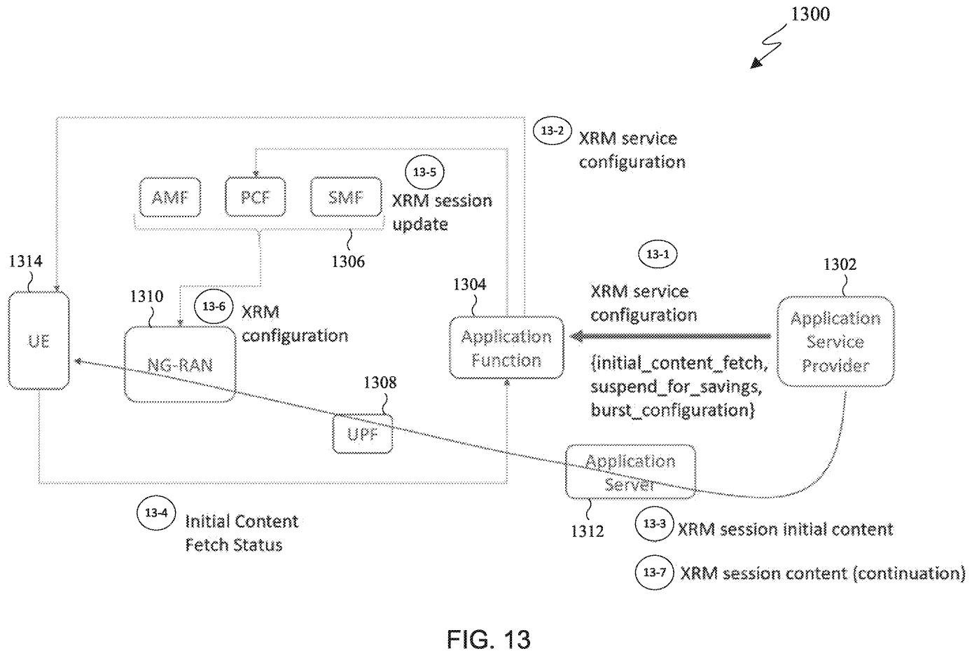

In traditional media streaming, and XR streaming use cases, it is often observed that clients receive content at a higher bit rate or throughput for an initial time period. Then the clients wait for some time to request next set of contents. A pattern can be seen here where after an initial content transfer, content is requested and received by the client in application bursts. There can be a periodicity associated with the burst (i.e., media content is received as a burst after every few milli seconds or seconds). There can also be a burst interval (i.e., the amount of time for each burst.) In some embodiments, all of this information may be used for resource saving and power saving schemes, similar shown in FIG. 13.

FIG. 13 illustrates an example procedure for radio resource and power savings in an NG-RAN and a UE based on application traffic characteristics 1300 according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for radio resource and power savings in an NG-RAN and a UE based on application traffic characteristics could be used without departing from the scope of this disclosure.

In the example of FIG. 13, the procedure 1300 begins at step 13-1. At step 13-1, an application service provider 1302 is aware of an amount of initial_content_fetch times for different applications on different UEs (e.g., UE 1314) in the operator network and configures those parameters as described herein. Along with the initial content fetch time, the application service provider 1302 may also enable a “suspend_for_savings” boolean flag in the service configuration information. In addition, the application service 1302 provider may also include burst configuration information. The following information may be configured as part of the burst configuration information:
burst_periodicity_post_initial_content_fetch: The periodicity with which application content bursts are expected to be seen by the data forwarding entities such as the UPF 1308 and NG-RAN 13101 nodes. Maximum/minimum/average values for this parameter may be configured by the application service provider in this procedure
burst_samples: Number of bursts based on which the other burst configuration parameters are approximated or computed against
burst_interval or burst_size: Time period for each burst. Application service provider may configure maximum/average/minimum values of this parameter based on ‘burst_samples’ number of bursts
service_burst_bandwdth_required_DL: Bandwidth required in the downlink direction for application content burst. Maximum/minimum/average values for this parameter may be configured by the application service provider in this procedure
service_burst_bandwdth_required_UL: Bandwidth required in the uplink direction for application content burst. Maximum/minimum/average values for this parameter may be configured by the application service provider in this procedure

Based on the received XRM service configuration information including the initial_content_fetch, suspend_savings, and burst_configuration information, the Application Function 1304 may provide these details to the other network functions 1306 (e.g., PCF) as described herein. The PCF and other network entities 1306, may then provide content processing policies and share with UPF 1308 and NG-RAN 1310 as described earlier in other embodiments. NG-RAN 1310 and UPF 1308 perform radio and core network resource allocation as described herein.

At step 13-2 the UE application (i.e., of UE 1314) may retrieve the XRM service configuration information from the Application Function 1312 using the M5 interface (for example, as specified in TS 26.501 and TS 26.510 as described herein.

At step 13-3, the UE 1314 receives XRM media content from the Application server 1312. Since enough radio bearer resources were setup in step 13-1 above, the initial XRM content is delivered to the UE 1314.

At step 13-4, the UE 1314 and/or the application of the UE 1314 informs the Application Function 1304 that it is done with initial content fetch, and enough content is buffered in the UE 1314 application buffer. To provide this information, the UE 1314 and/or the UE application may use the M5 interface (for example, as specified in 3GPP TS 26.501 and TS 26.510).

At step 13-5, the Application Function may perform an update of the XRM service configuration at the network operator functions 1306 to indicate that the initial content fetch is complete, and it may be some time before radio resources are necessary to transmit XRM content to the end user. The Application Function 1304 may recommend the network operator functions such as NG-RAN 1310 to suspend radio resources allocated to the UE 1314. Furthermore, the Application Function 1304 may also send the burst_configuration information if it did not send the burst_configuration as described in Step-1 above.

At step 13-6, based on the above information from the Application Function 1304, the network operator functions 1306 may suspend radio resources allocated to the UE by requesting NG-RAN 1310 and UPF 1308 to initiate procedures such as the resource savings and power savings described herein. When the NG-RAN 1310 receives this information, it may suspend the radio resources allocated to the UE 1314. Alternatively, the NG-RAN 1310 may initiate power saving schemes (for example, similar as described in 3GPP TS 23.501 and TR 23700-70). Optionally, the network operator functions 1306 may also include a flag called “activate-upon-new-media” to signal to NG-RAN 1310 that if it sees new media content for this service, then it is to re-activate the radio resources or stop the power saving schemes. In addition, the network functions 1306 may send updated media content processing policies based on the burst_configuration information they received from the Application Function 1304. The network functions 1306 may request UPF 1308 and NG-RAN 1310 to allocate required resources based on the burst parameters.

In some embodiments, if the network functions 1306 provide burst periodicity information, NG-RAN 1310 performs procedures to activate radio bearers during an upcoming burst. For example, NG-RAN 1310 may use the burst periodicity information, burst_samples, and burst_interval to estimate the time period to the next burst from the time the previous burst was observed. When the time period was computed, NG-RAN 1310 then computes the time left before the burst is expected. Based on this, NG-RAN 1310 de-activates the radio resources for the amount of time still left to the next application burst. When the time for next expected burst is reached, the NG-RAN re-activates radio resources. The NG-RAN may follow similar computations to activate and de-activate power saving schemes as described herein in other embodiments.

At step 13-7, when the media content of the XRM service reaches the NG-RAN 1310 (e.g., when a new PDUSet is received by NG-RAN 1310), an application burst is observed, and the NG-RAN 1310 has radio resources allocated so the UE 1314 continues to receive new media content for the XRM service. When the transfer of the burst is complete, NG-RAN 1310 may de-activate radio resources or start the power saving schemes as described herein until the next burst based on the received burst parameters.

The activation and de-activation of radio resources by NG-RAN 1310, and/or the power saving schemes repeat based on the burst configuration parameters received above.

Although FIG. 13 illustrates one example procedure for radio resource and power savings in an NG-RAN and a UE based on application traffic characteristics 1300, various changes may be made to FIG. 13. For example, while shown as a series of steps, various steps in FIG. 13 could overlap, occur in parallel, occur in a different order, occur any number of times, be omitted, or replaced by other steps.

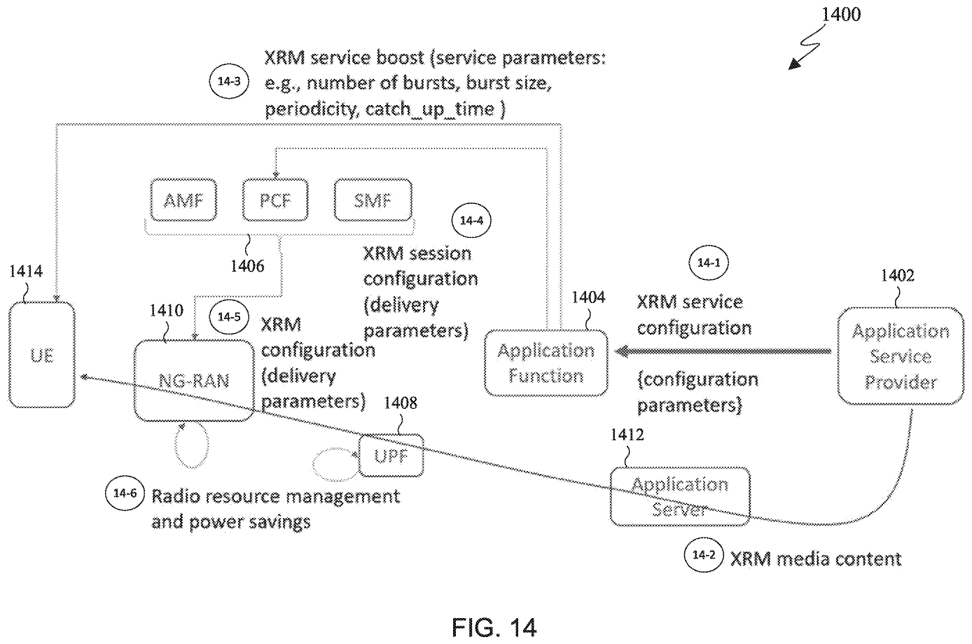

In some embodiments, a UE may request a temporary boost in network throughput for the application session from a network apparatus entity (e.g., the 5G Media Streaming Application Function, referred to here as AF) (for example, similar as described in (3GPP TS 26.401 and TS 26.512). The AF may then facilitate delivery of application traffic at a higher pace to satisfy the UE client's request for a temporary boost. In some embodiments, this network boost procedure may accommodate traffic characteristics of XRM data to facilitate a temporary boost in XRM traffic delivery, similar as shown in FIG. 14.

FIG. 14 illustrates an example procedure for a temporary service boost for XRM service 1400 according to embodiments of the present disclosure. An embodiment of the procedure illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a procedure for 14 could be used without departing from the scope of this disclosure.

In the example of FIG. 14, the procedure 1400 begins at step 14-1. At step 14-1, an application service provider 1402 performs service configuration for XRM service at the Application Function 1404 similar as described herein. Based on the configured service information, the AF 1404 may interact with other network functions such 1406 such as a PCF, NEF, etc., to facilitate the QoS required for XRM service content delivery. The network functions may then inform data forwarding entities in the core network and radio network such as UPF 1408 and NG-RAN 1410 to facilitate QoS of the XRM service similar as described herein.

At step 14-2, after the XRM service configuration in the operator network, the application service provider 1402 may ingest XRM service content (e.g., using the M2 interface similar as described in 3GPP TS 26.501 and TS 26.510. The ingested content is then delivered to the UE 1414 (e.g., using the M4 interface similar as described in 3GPP TS 26.501 and TS 26.512).

After some time, at step 14-3, the UE 1414, or the client app on the UE 1414, may notice that it is not able to keep up with the consumption rate of the media content at the UE application (e.g., using buffer status information of different media components and the rate at which they are being consumed by the application on the UE). The UE 1414, or the UE client application, may request a temporary service boost (network boost) (e.g., using the M5 procedure similar as describe in 3GPP TS 26.501 and TS 26.510). However, the existing M5 procedure for network boost does not include enough information for the AF 1414 to make informed decisions about XR data processing. To overcome this limitation, the network boost procedure of FIG. 14 includes at least one of the parameters in Table 3 in the request from the UE to the AF.

TABLE 3
XRM Service Boost Information

| Parameter | Description |
|---|---|
| Current resolution | Current resolution of the content that is being consumed |
| Current representation | Content representation information of the content that is |
| | currently being consumed. The representation information |
| | is copied from the media description document the UE |
| | 1414 received from the Media Application server 1412 |
| | (e.g., from DASH MPD) |
| Current adaptation | Current adaptation information (e.g., as described in the |
| | media description document from 3GPP TS 26.501 and TS |
| | 26.510) |
| burst_size | The size of the bursts that it is receiving for the content that |
| | it is currently receiving |
| number_of_bursts | Number of bursts that the client desires to receive as |
| | response to service/network boost request |
| | Client may indicate a value of 1 which represents that |
| | intends to receive the whole service boost response content |
| | as one burst |
| catch_up_time | The current catch_up_time as observed at the UE |
| | application for the current representation, adaptation, and |
| | resolution. The catch_up_time is described in the earlier |
| | embodiments |
| bust periodicity | Current burst periodicity for the content that is currently |
| | being received at the UE 1414 |
| initial_content_fetch | Indicates whether the UE 1414 shows interest in receiving |
| | initial content followed by a number of bursts |
| time_period_service_boost | Total time for which the network boost or service boost is |
| | desired by the UE application. |
| UE client information | Application information such as whether it a browser app |
| | or IOS app or Android app etc. |
| UE client app | UE client application information e.g., Android App |
| information | package information |

At step 14-4, based on the above request received from the UE 1414, the AF 1404 then infers the delivery parameters to satisfy network boost request from the UE application. The delivery parameters could be one or more of the parameters from Table 4.

TABLE 4
Network Boost Delivery Parameters

| Parameter | Description |
|---|---|
| burst_size | The size of the burst that the client needs to receive to |
| | satisfy service boost request |
| number_of_bursts | Number of bursts that the network decided to provide to |
| | the UE to satisfy service/network boost request |
| | The Application Function attempts to satisfy the number |
| | of bursts from the UE application. Sometimes, if the AF |
| | cannot satisfy the number of bursts from the UE, the AF |
| | may derive the number of bursts value based on current |
| | network conditions and UE traffic reception conditions |
| burst periodicity | Burst periodicity for the content that is to be delivered to |
| | the UE to satisfy the service boost request |
| min/avg/max | Minimum/Average/Maximum expected throughput in |
| service_throughput_DL_service_boost | the downlink direction from the network to the UE for |
| | the XRM service during the service/network boost |
| | response procedure |
| min/avg/max | Minimum/Average/Maximum expected bandwidth to be |
| service_bandwidth_required_DL_service_boost | provisioned by the operator in the downlink direction |
| | from the network to the UE for the XRM service during |
| | the service/network boost response procedure |
| suspend_for_savings | Indicates whether the AF intends that the network |
| | operate undertake resource management and power |
| | management savings procedures as described earlier in |
| | the disclosure |
| | The Application service provider or the AF may intend |
| | that for service/network boost requests from the UE, the |
| | network may decide to enable or disable radio resource |
| | management and/or power savings procedures described |
| | in this disclosure |

At step 14-5, based on the service/session update from the AF 1404, the network operator functions 1406 may derive updated QoS rules and inform them to the NG-RAN 1410 and/or UPF 1408 similar as described herein. The network functions 1406 may also inform NG-RAN 1410 and/or UPF 1408 of derived delivery parameters in step 14-4 to NG-RAN 1410 and/or UPF 1408 similar as described herein.

At step 14-6, the NG-RAN 1410 and/or UPF 1408 may perform radio resource management and power savings procedures similar as described herein based on information or delivery parameters received from the network functions 1406.

Although FIG. 14 illustrates one example procedure for a temporary service boost for XRM service 1400, various changes may be made to FIG. 14. For example, while shown as a series of steps, various steps in FIG. 14 could overlap, occur in parallel, occur in a different order, occur any number of times, be omitted, or replaced by other steps.

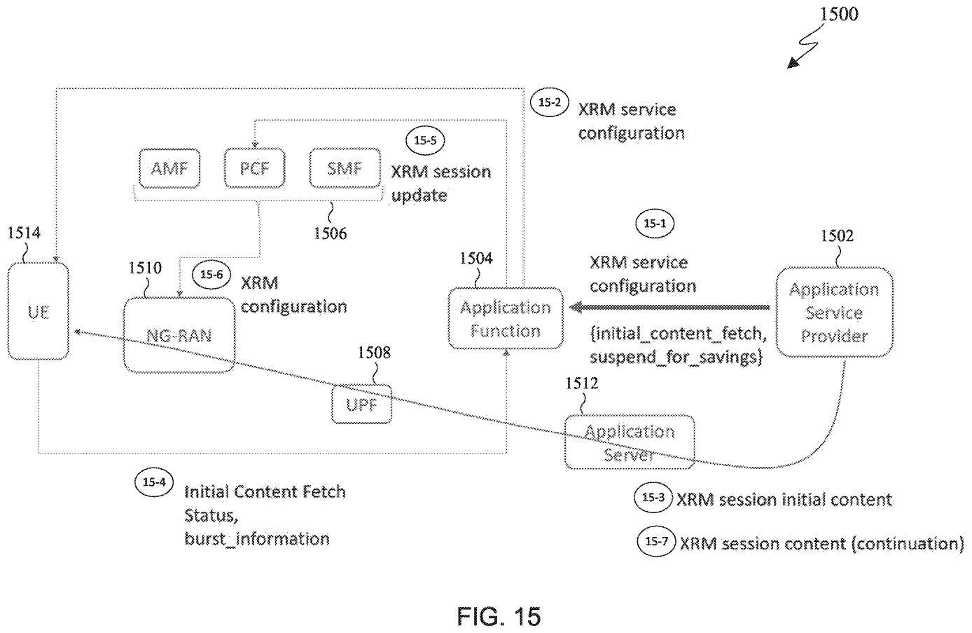

In the embodiment of FIG. 13, resource savings in an NG-RAN and UE throughout the application session are based on application traffic characteristics. In some embodiments, a similar procedure may use the burst parameters received from the UE as opposed to the application service provider, similar as shown in FIG. 15.

FIG. 15 illustrates an example procedure for radio resource and power savings in an NG-RAN and UE based on application burst configuration and UE feedback 1500 according to embodiments of the present disclosure. An embodiment of the procedure illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a procedure for radio resource and power savings in an NG-RAN and UE based on application burst configuration and UE feedback could be used without departing from the scope of this disclosure.

In the example of FIG. 15, the procedure 1500 begins at step 15-1. At step 15-1, an application service provider 1502 is aware of amount of initial_content_fetch times for different applications on different UEs (e.g., UE 1514) in the operator network and configures those parameters as described herein. Along with the initial content fetch time, the application service provider 1502 may also enable a “suspend_for_savings” boolean flag in the service configuration information. Based on the received XRM service configuration information including the initial_content_fetch and suspend_savings, the Application Function 1504 may provide these details to the other network functions 1506 (e.g., a PCF) as described herein. The PCF and other network entities 1506 may then provide content processing policies and share with UPF 1508 and NG-RAN 1510 as described herein. NG-RAN 1510 and UPF 1508 perform radio and core network resource allocation as described herein.

At step 15-2 the UE application (of UE 1514) may retrieve the XRM service configuration information from the Application Function 1504 (e.g., using the M5 interface similar as described in 3GPP TS 26.501 and TS 26.510).

At step 15-3, the UE 1514 receives XRM media content from the Application server 1512. Since enough radio bearer resources were setup in Step 14-1, the initial XRM content is delivered to the UE 1514.

At step 15-4, the UE 1514 and/or the application of the UE 1514 informs the Application Function 1504 that it has completed the initial content fetch, and enough content is buffered in the UE application buffer. To provide this information, the UE 1514 and/or the UE application may use the M5 interface (e.g., similar as described in 3GPP TS 26.501 and TS 26.510). The UE 1514 may also send application burst information to the Application Function 1504. The burst information may include the following information:
burst_periodicity_post_initial_content_fetch: The periodicity with which application content bursts are observed. Maximum/minimum/average values for this parameter may be sent to the Application in this procedure
burst_samples: Number of bursts based on which the other burst parameters are approximated or computed against
burst_interval: Time period for each burst. UE 1514 may provide maximum/average/minimum values of this parameter based on ‘burst_samples’ number of bursts
service_burst_bandwdth_required_DL: Bandwidth required in the downlink direction for application content burst. Maximum/minimum/average values for this parameter may be provided by the UE 1514 or UE application in this procedure
service_burst_bandwdth_required_UL: Bandwidth required in the uplink direction for application content burst. Maximum/minimum/average values for this parameter may be provided by the UE or UE application in this procedure

At step 15-5, the Application Function 1504 may perform an update of the XRM service configuration at the network operator functions 1506 to indicate that the initial content fetch is complete, and it may be some time before radio resources are necessary to transmit XRM content to the end user (UE 1514). The Application Function 1504 may recommend the network operator functions such as NG-RAN 1510 to suspend radio resources allocated to the UE 1514. Further the Application Function 1504 may also send the burst related information it received from the UE 1514 to other network functions.

At step 15-6, based on the above information from the Application Function 1504, the network operator functions 1506 may suspend radio resources allocated to the UE 1514 by requesting NG-RAN 1510 and UPF 1508 to initiate resource savings and power saving procedures. When the NG-RAN 1510 receives this information, it may suspend the radio resources allocated to the UE 1514. Alternatively, the NG-RAN 1510 may initiate power saving schemes (e.g., similar as described in 3GPP TS 23.501 and TR 23700-70). Optionally, the network operator functions 1506 may also include a flag called “activate-upon-new-media” to signal to the NG-RAN 1510 that if it sees new media content for this service, then it is to re-activate the radio resources or stop the power saving schemes. In addition, the network functions 1506 may send updated media content processing policies based on the burst related information they received from the Application Function 1504. The network functions 1510 may request UPF 1508 and NG-RAN 1510 to allocate required resources based on the burst parameters.

If the network functions 1506 provide burst periodicity information, NG-RAN 1510 performs procedures to activate radio bearers during upcoming burst. For example, NG-RAN 1510 may use the burst periodicity information, burst_samples, and burst_interval to estimate the time period to the next burst from the time the previous burst was observed. When the time period is computed, NG-RAN 1510 then computes the time left before the burst is expected. Based on this, NG-RAN 1510 de-activates the radio resources for the amount of time still left to the next application burst. When the time for next expected burst is reached, the NG-RAN 1510 re-activates radio resources. NG-RAN 1510 may follow similar computations to activate and de-activate power saving schemes as described herein.

At step 15-7, when the media content of the XRM service reaches the NG-RAN 1510 (e.g., when a new PDUSet is received by NG-RAN 1510), an application burst is observed, and the NG-RAN 1510 has radio resources allocated so the UE 1514 continues to receive new media content for the XRM service. When the transfer of burst is complete, NG-RAN 1510 may de-activate radio resources or start the power saving schemes similar as described herein until the next burst based on the received burst parameters.

The activation and de-activation of radio resources by NG-RAN 1510, and/or the power saving schemes repeats based on the burst configuration parameters received above.

Although FIG. 15 illustrates one example procedure for radio resource and power savings in an NG-RAN and UE based on application burst configuration and UE feedback 1500, various changes may be made to FIG. 15. For example, while shown as a series of steps, various steps in FIG. 15 could overlap, occur in parallel, occur in a different order, occur any number of times, be omitted, or replaced by other steps.

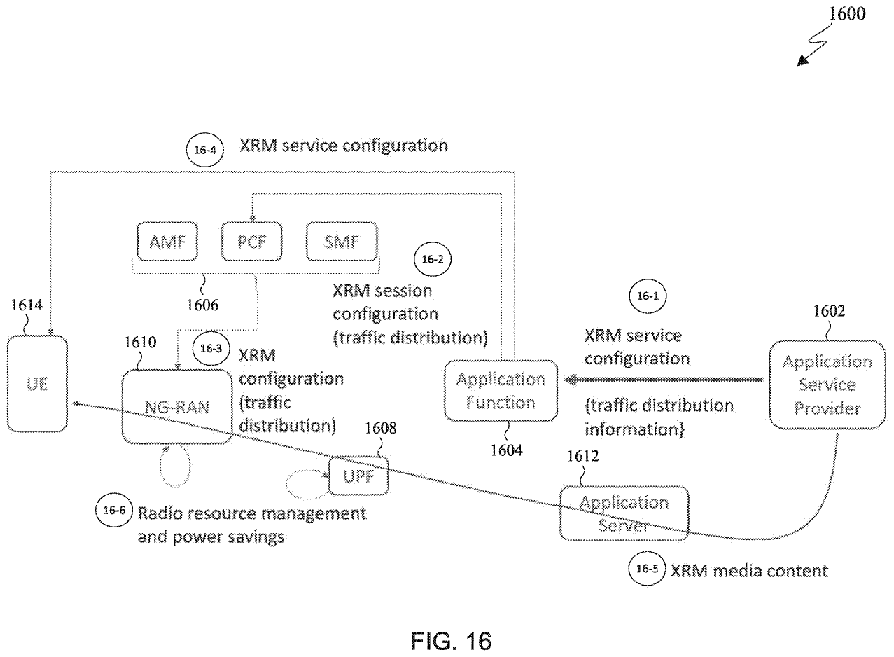

In some embodiments, traffic distribution functions may be used in a procedure for resource savings in an NG-RAN and UE, similar as shown in FIG. 16.

FIG. 16 illustrates an example procedure for radio resource and power savings in an NG-RAN and UE based on traffic distribution information 1600 according to embodiments of the present disclosure. An embodiment of the procedure illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of a procedure for radio resource and power savings in an NG-RAN and UE based on traffic distribution information could be used without departing from the scope of this disclosure.

In the example of FIG. 16, the procedure 1600 begins at step 16-1. At step 16-1, an application service provider 1602 is aware of traffic distribution at the source. For example, the application service provider may do traffic modeling to infer the traffic distribution information of the content it intends to ingest into the 5G network for the XRM service. The application service provider 1602 configures XRM service configuration information at the Application Function 1604 in the operator network as described herein. As part of the service configuration information, the Application service provider includes the traffic distribution function information.

The traffic distribution function is modeled using a Probability Distribution Function (PDF) where for the PDF f(x,y), given an input parameter x representing the elapsed time for the service since the service begin time and time duration y, generates the following information:
Expected time stamps for upcoming PDUSets for the application service within time duration y
Expected inter-arrival packet time stamps within time duration y
Expected burst periodicity in application traffic within time duration y
Expected burst interval times within time duration y
Any other traffic characteristics information described herein.

At step 16-2, when the Application Function 1604 receives the XRM service configuration information with the above traffic distribution function, it parses the request and derives expected traffic distribution information. The Application Function 1604 may inform the 5G system network functions 1606 about the above traffic distribution information

At step 16-3, the network components 1606 (e.g., the PCF) may generate updated QoS policies to cater to the expected traffic distribution, and share them with the other network components 1606 (e.g., SMF), which in turn may share the policy information at the UPF 1608 and NG-RAN 1610 for the XRM traffic. As part of this configuration, the NG-RAN 1610 and/or UPF 1608 may be informed of the derived traffic distribution information. Optionally, the NG-RAN 1610 and/or the UPF 1608 may be informed of the traffic distribution PDF that may assist NG-RAN 1610 and/or UPF 1608 to derive traffic distribution information themselves

At step 16-4, the UE application (of UE 1614) may retrieve the XR media service configuration information from the Application Function 1604 (e.g., using the ServiceAccessConfiguration procedure similar as described in 3GPP TS 26.501 and TS 26.510.

After the XRM service provisioning, at step 16-5 the Application Service Provider 1602 may ingest XRM service content into the operator network. Application PDUSets may be transmitted between the Application Server 1612 and the UE 1614. The operator network functions such as UPF 1608 and NG-RAN 1610 may perform the policies and procedures configured by the network functions 1606 (i.e., the PCF via the SMF) on the above PDUSet traffic.

Based on the configured traffic distribution function, at step 16-6, when NG-RAN 1610 and/or UPF 1608 start seeing traffic of the application service, they may use the configured traffic distribution function to derive traffic characteristics information such as inter-arrival time, expected bursts for upcoming PDUSets, burst periodicities, burst interval times etc. as defined in earlier steps. When NG-RAN 1610 derives traffic characteristics information, and notices that it may be some time before the application traffic is again observed for the service, it may perform radio resource management or power saving schemes as described herein.

Although FIG. 16 illustrates one example procedure for radio resource and power savings in an NG-RAN and UE based on traffic distribution information 1600, various changes may be made to FIG. 16. For example, while shown as a series of steps, various steps in FIG. 16 could overlap, occur in parallel, occur in a different order, occur any number of times, be omitted, or replaced by other steps.

When an external XR application service provider provides an XR service, and if a mobile user is interested in consuming that XR service, the user may connect/tether one or more XR companion devices to the UE to augment the XR application experience to the end user. Examples of such XR companion devices include Head Mounted Displays (HMDs), gloves and backpacks (for haptic signals), and displays for 3D rendering. For a fully functional experience of XR applications, all aspects related to management of such XR companion devices should be addressed.

The tethering of XR tethered devices to the tethering UE may happen using any communication technologies (wired connectivity, WIFI, Bluetooth etc.) depending on the capabilities of those tethered XR devices. Different connectivity technologies bring different features and challenges, and also have different QoS characteristics. So, when the UE is involved in an XR session, the QoS implications due to each different type of XR companion device could be different because of its capabilities, and the capabilities of the tether link.

One of the problems with using tethered devices in an application session is that these devices come with a varied set of capabilities and QoS guarantees. Some of these tethered devices are limited power devices where all the content processing happens outside the tethered device, while some tethered devices have complex content processing capabilities. So, methods and solutions have to be defined to facilitate content management at all levels. Existing media streaming solutions focus on delivering content destined to one or more of these tethered devices from the network to the UE. Because of the nature of these tethered devices, and the real-time nature of application services, it is sometimes feasible that content management is performed locally on the connected UE. Various embodiments of the present disclosure provide mechanisms for management of content destined to tethered devices connected to a UE given their current QoS and energy conditions.

As described herein, a tethered device behind a UE may be referred to as an XRM device or a tethered device, and the UE may be referred to as a tethering UE.

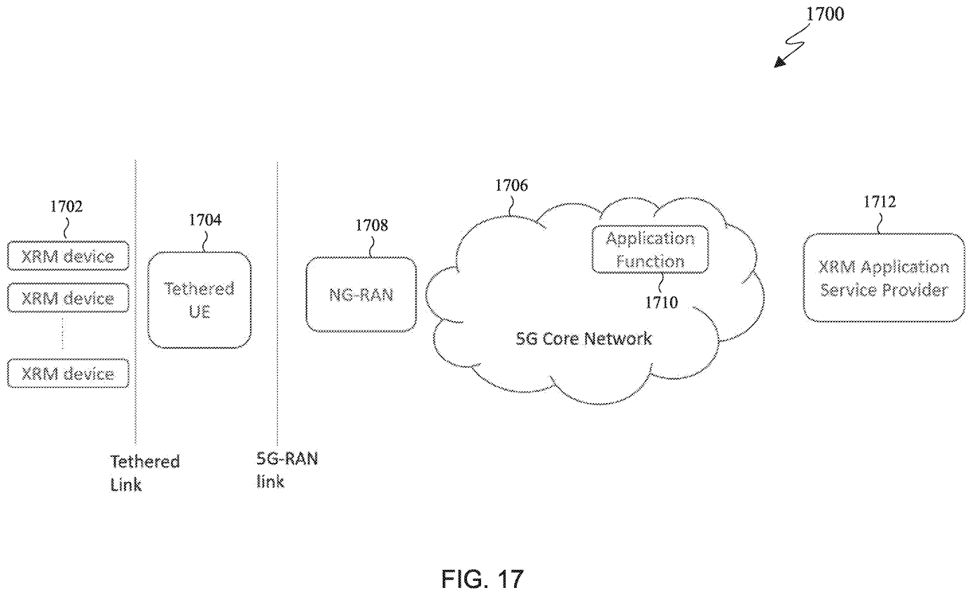

FIG. 17 illustrates an example of tethered devices behind a UE for XRM services 1700 according to embodiments of the present disclosure. The embodiment of tethered devices behind a UE for XRM services of FIG. 17 is for illustration only. Different embodiments of tethered devices behind a UE for XRM services could be used without departing from the scope of this disclosure.

In the example of FIG. 17, an overall connectivity architecture of different components in a 5G system is shown. This includes the following:
One or more XRM devices 1702 are tethered to a UE 1704. These devices communicate with the UE 1704 using a tethered link of different types and characteristics.
The tethering UE 1704 is connected to the 5G network 1706 using the traditional 5G RAN communication link 1708
The Application Function 1710 shown as part of the 5G core network 1706 could the 5GMS Application Function from 3GPP TR 26.501.
The XRM Application Service Provider 1712 shown in FIG. 17 could be the 5GMS Application Provider from 3GPP TR 26.501 and that is providing XRM services to subscribed users.

Although FIG. 17 illustrates one example tethered devices behind a UE for XRM services 1700, various changes may be made to FIG. 17. For example, various changes to the number of tethered devices could be made, etc., according to particular needs.

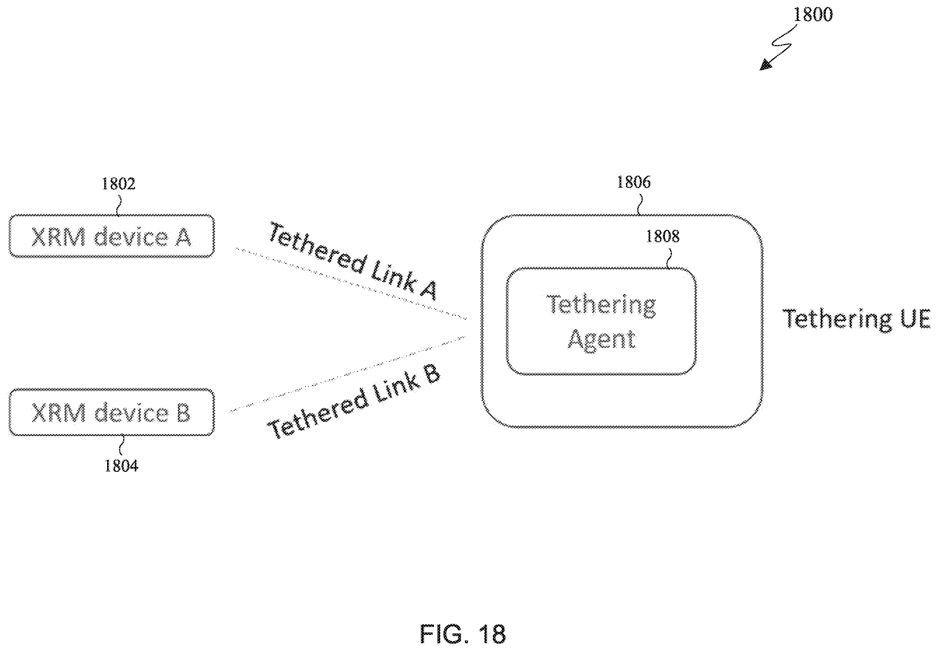

In some embodiments, a tethering agent in a UE may manage one or more tethered devices behind the UE, similar as shown in FIG. 18.

FIG. 18 illustrates an example tethering agent in a UE managing tethered devices 1800 according to embodiments of the present disclosure. The embodiment of a tethering agent of FIG. 18 is for illustration only. Different embodiments of a tethering agent could be used without departing from the scope of this disclosure.

In the example of FIG. 18, two tethered devices 1802 and 1804 (XRM device A and XRM device B) are connected to the UE 1806 using two different tethered links (communication links). The two types of tethered links may be of differing types. So, each link may exhibit different characteristics. The tethering agent 1808 of the UE 1806 manages the tethered devices 1802 and 1804

Although the example of FIG. 18 illustrates a connection of two tethered devices using two different tethered link types to the UE 1806, the procedures and functionalities described herein are applicable for multiple tethered devices and multiple tethered link types.

Although FIG. 18 illustrates one example tethering agent in a UE managing tethered devices 1800, various changes may be made to FIG. 18. For example, various changes to the number of tethered devices could be made, etc., according to particular needs.

The present disclosure defines the concept of a Client Tethered QoS Specification as a representation of QoS specifications given the QoS characteristics of all tethered devices and tethered links attached to the tethering UE.

To define the Client Tethered QoS Specification, an individual tethered QoS specification is defined in the present disclosure as the collection of all current QoS parameters pertaining to a single tethered device and the connecting tethered link. For example, in the example of FIG. 18, there are two individual tethered QoS specifications, one for each of tethered device 1802 [XRM device A, Tethered Link A] and 1804 [XRM device B, Tethered Link B] tether connections. An individual QoS specification may represent the QoS parameters of Table 5 in the collection.

TABLE 5
Individual Tethered QoS parameters

| Parameter | Description |
|---|---|
| Id | Identification of tethered device |
| Downlink Bit Rate | Bit rate of traffic from the tethering UE to the tethered |
| | device/XRM device over the tethered link |
| Uplink Bit Rate | Bit rate of traffic from the tethered device/XRM device over |
| | the tethered link to the tethering UE |
| Desired Downlink Bit Rate | Desired bit rate of traffic from the tethering UE to the |
| | tethered device/XRM device over the tethered link. This is |
| | the downlink bit rate desired by the tethered device for |
| | traffic from the tethering UE to the tethered device. |
| Desired Uplink Bit Rate | Desired bit rate of traffic from the tethered device/XRM |
| | device over the tethered link to the tethering UE. This is the |
| | uplink bit rate desired by the tethered device for traffic from |
| | the tethered device to tethering UE. |
| Downlink Packet Latency | Packet latency for traffic from the tethering UE to the |
| | tethered device/XRM device over the tethered link |
| Uplink Packet Latency | Packet latency traffic from the tethered device/XRM device |
| | over the tethered link to the tethering UE |
| Desired Downlink Packet | Desired packet latency for traffic from the tethering UE to |
| Latency | the tethered device/XRM device over the tethered link. This |
| | is the packet latency desired by the tethered device in the |
| | downlink direction i.e. from tethering UE to tethered |
| | device. |
| Desired Uplink Packet | Desired packet latency traffic from the tethered |
| Latency | device/XRM device over the tethered link to the tethering |
| | UE. This is the packet latency desired by the tethered device |
| | in the uplink direction i.e. from tethered device to tethering |
| | UE. |
| Downlink Packet Loss Rate | Packet loss rate for traffic from the tethering UE to the |
| | tethered device/XRM device over the tethered link |
| Uplink Packet Loss Rate | Packet loss rate for traffic from the tethered device/XRM |
| | device over the tethered link to the tethering UE |
| Desired Downlink Packet | Desired packet loss rate for traffic from the tethering UE to |
| Loss Rate | the tethered device/XRM device over the tethered link. This |
| | is the packet loss rate desired by the tethered device in the |
| | downlink direction i.e. for traffic from tethering UE to |
| | tethered device. |
| Desired Uplink Packet Loss | Desired packet loss rate for traffic from the tethered |
| Rate | device/XRM device over the tethered link to the tethering |
| | UE. This is the packet loss rate desired by the tethered |
| | device in the uplink direction i.e. from tethered device to |
| | tethering UE. |
| Downlink PDUSet QoS | PDUSet QoS parameters of traffic from the tethering UE to |
| parameters | the tethered device/XRM device over the tethered link. The |
| | PDUSet QoS parameters may be similar as described in |
| | 3GPP TS 26.510 |
| Uplink PDUSet QoS | PDUSet QoS parameters of traffic from the tethered device |
| parameters | to tethering UE over the tethered link. The PDUSet QoS |
| | parameters may be similar as described in 3GPP TS 26.510. |
| Desired Downlink PDUSet | Desired PDUSet QoS parameters for traffic from the |
| QoS parameters | tethering UE to the tethered device/XRM device over the |
| | tethered link. The PDUSet QoS parameters are specified in |
| | TS 26510. These are the PDUSet QoS parameters desired |
| | by the tethered device in the downlink direction i.e. for |
| | traffic from tethering UE to tethered device. |
| Desired Uplink PDUSet QoS | Desired PDUSet QoS parameters of traffic from the tethered |
| parameters | device to tethering UE over the tethered link. The PDUSet |
| | QoS parameters may be similar as described in 3GPP TS |
| | 26.510. These are the PDUSet QoS parameters desired by |
| | the tethered device in the uplink direction i.e. for traffic |
| | from tethered device to tethering. |

Given the one or more individual tethered QoS specifications, a Client Tethered QoS specification can be of the structure of Table 6.

TABLE 6
Client Tethered QoS parameters

| Parameter | Description |
|---|---|
| Individual tethered QoS | An array of individual tethered QoS specifications. Each |
| specification array | member of this array is of the structure described earlier |
| | in the disclosure |
| Tether device | Map of priorities associated with each individual tethered |
| priority map | connection to a given tethered device. |
| | Higher priority tethered connections to tethered devices |
| | receive preferential treatment according to the procedures |
| | described in this disclosure. |
| Content type map | Map of content types. Each element of the map is of the form < |
| | key, value > pair where key represents the identification |
| | of the tethered device, and value represents the content |
| | type the tethered device may consume. Example, an HMD tethered |
| | device may consume both audio and video content types, while a |
| | hand glove tethered device may only consume haptic signals. |

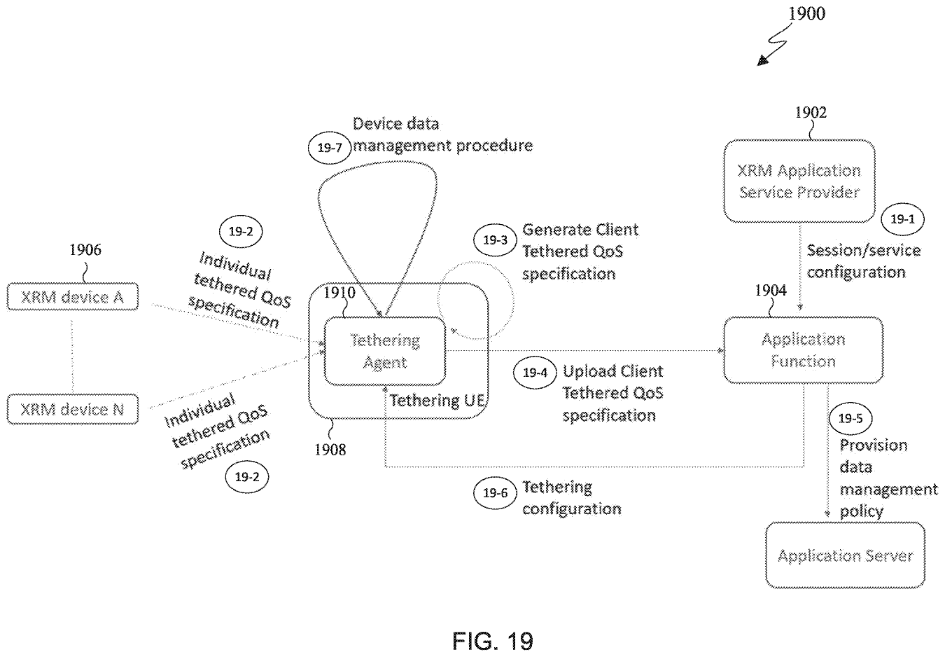

In some embodiments, tethered device data management given current QoS conditions using may be similar as shown in FIG. 19.

FIG. 19 illustrates an example procedure for tethered device data management based on current QoS 1900 according to embodiments of the present disclosure. An embodiment of the procedure illustrated in FIG. 19 is for illustration only. One or more of the components illustrated in FIG. 19 may be implemented in specialized circuitry configured to perform the noted functions or one or more of the components may be implemented by one or more processors executing instructions to perform the noted functions. Other embodiments of a procedure for tethered device data management based on current QoS could be used without departing from the scope of this disclosure.

The example of FIG. 19 shows a schematic of the tethered device data management given the current QoS using the facilities described herein.

In the example of FIG. 19, the procedure 1900 begins at step 19-1. At step 19-1 An XRM Application Service provider performs a session and service management at the Application Function 1904 (e.g., similar as described in 3GPP TS 26.501 and TS 26.510.

At step 19-2, each XRM tethered device 1906 connected to a tethering UE 1908 may transmit individual tethered QoS specification to the Tethering Agent 1910 in the UE 1908. The individual tethered QoS specification for each tethered device 1906 and tethered link may be as described herein.

At step 19-3 the Tethering Agent 1910 in the UE 1908, upon receiving one or more individual tethered QoS specifications from each of the connected tethered devices 1906, generates the Client Tethered QoS specification as described herein.

At step 19-4, the generated Client Tethered QoS specification is shared/uploaded to the Application Function 1904 in the core network

At step 19-5, the Application Function 1904, based on the received Client Tethered QoS specification, and the configured service/session parameters by the XRM Application Service Provider 1902, infers the desired tethering configuration across all the connected tethered devices. In some embodiments, the tethering configuration may have the information from Table 7.

TABLE 7
Tethering Configuration Information

| Information | Description |
|---|---|
| Synchronization | Configuration to facilitate synchronization of data |
| configuration | across all the connected tethered devices. The |
| | details of the synchronization information are |
| | described later in this disclosure |
| Data management | Information to notify data management decision for |
| notification | data streams destined to the tethered devices. The |
| information | details of the data management notification |
| | information are described later in this disclosure. |
| | Corresponding to the notification information, the |
| | Application Function may interact with the |
| | Application Server to perform management of |
| | delivery of data streams destined to one or more of |
| | tethered devices connected to the tethering UE. |

At step 19-6, the tethering configuration is then sent to the Tethering Agent 1910 in the UE 1908.

At step 19-7, the Tethering Agent 1910, based on the received tethering configuration, performs procedures as described herein.

Although FIG. 19 illustrates one example procedure for tethered device data management based on current QoS 1900, various changes may be made to FIG. 19. For example, while shown as a series of steps, various steps in FIG. 19 could overlap, occur in parallel, occur in a different order, occur any number of times, be omitted, or replaced by other steps.

As described earlier herein, an Application Function, upon receiving a Client Tethered QoS specification, may generate a tethered configuration and send it to the Tethering Agent in a UE. In some embodiments, one of the details included in the tethered configuration can be the synchronization information.

The synchronization information instructs the Tethering Agent how to synchronize data streams across one or more of the connected tethered devices. It is desirable for the Tethering Agent at the UE to perform synchronization due to the following reasons:
It is possible that the Application Function, or an Application Server (e.g., similar as described in 3GPP TS 26.501 and TS 265.10) do not know that the UE is using one or more tethered devices.
Alternatively, it is possible that the Application Function or the Application Server prefer to send data streams to the UE irrespective of the tethering setup at the UE. In essence, the Application Function or the Application Server, send data streams in the same format as if there were no tethered devices connected to the tethering UE.
   If the data streams are sent to the UE in a multiplexed format, e.g., MPEG2TS where different types of data streams are multiplexed and sent together.

Note that in the case of separate streams for different tethered devices (e.g. if the data streams are sent in different RTP streams (e.g., with a different SSRC), then individual streams can be sent to individual tethered devices.

To help with synchronization of data streams destined to different tethered devices, the information from Table 8 may be included in the synchronization configuration information sent from the Application Function to the tethering UE.

TABLE 8
Synchronization Information

| Information element | Description |
|---|---|
| Reference clock | Configuration of reference clock to be used at the tethering |
| | Agent to synchronize delivery of data streams destined to one |
| | or more tethered devices. This information may have the |
| | following details: |
| | Clock time: Reference clock to use while distributing |
| | packets/frames to one or more tethered devices |
| | Time server URL: URL to a timing server to fetch the |
| | reference clock information |
| Sync interval | Time period after which the reference clock is re-synced to |
| | the time source. |
| bitrate map | Map of delivery bit rates. Each entry in the map is of the form < |
| | key, value > pair where key represents the identification of |
| | tethered device, and the value represents the bit rate of the |
| | content type the tethered device can consume. |
| Inter_packet_delay map | Map of inter packet delays. Each entry in the map is of the |
| | form < key, value > pair where key represents the |
| | identification of tethered device, and the value represents the |
| | packet delay while distributing each packet/frame of the |
| | content type the tethered device consumes. |
| Burst_configuration map | Map of burst configurations. Each entry in the map is of the |
| | form < key, value > pair where key represents the |
| | identification of tethered device, and the value represents the |
| | burst configuration of the content type the tethered device |
| | consumes. |
| | Burst configuration information may include the following |
| | details: |
| | Periodicity: How regular or periodic are the bursts |
| | Burst interval: Time period between two bursts in the |
| | content to be delivered to the tethered device |

As described earlier herein, an Application Function, upon receiving a Client Tethered QoS specification, may generate a tethered configuration and send it to the Tethering Agent in the UE. In some embodiments, one of the details included in the tethered configuration can be the data management notification information.

The data management notification information provides notification to the tethering UE about how individual data streams destined to each of the tethered devices given the current QoS conditions of each of the tethered devices and the tethered links are managed. The information from Table 9 may be provided by the Application Function to the tethering UE. In addition to notifying the tethering UE, the Application Function may interact with an Application Server to influence delivery decisions of data streams destined to one or more of tethered devices at the tethering UE.

TABLE 9
Data Management Notification Information

| Information Element | Description |
|---|---|
| Tethered device data management | Map providing data management notification. Each |
| notification map | member of the map is of the form <key, value> pair |
| | where in key represents the identification of the tethered |
| | device, and value represents a notification about the |
| | action that is to be undertaken. Following notification |
| | types may be provided as part of the value field. For |
| | each notification type, the Application Function may |
| | interact with the Application Server to manage delivery |
| | of data streams to one or more of the tethered devices |
| | connected to the tethering UE |
| | Continue data delivery notification: Continue |
| | data delivery given the current QoS conditions |
| | of the tethered device. |
| | In this option, Application Function does not |
| | change the current behavior of data delivery to |
| | the tethering UE. Therefore, no interaction with |
| | the Application Server is performed. |
| | Paused delivery of data stream notification: |
| | Pause delivery of data stream for a certain |
| | period of time to the given tethered device. If |
| | this is specified, the Application Function may |
| | also include time interval in the notification |
| | information during which the data stream is not |
| | delivered to the tethered device. Upon expiry of |
| | given time interval, the tethering UE may |
| | receive data stream destined to the tethered |
| | device. |
| | When this notification is sent out, the |
| | Application Function interacts with the |
| | Application Server to pause delivery of data |
| | stream destined to given tethered device for the |
| | specified time interval. |
| | Terminate delivery of data stream notification: |
| | Terminate delivery of data stream until decided |
| | later to restart delivery of data stream. |
| | When this notification is sent out, the |
| | Application Function interacts with the |
| | Application Server to terminate delivery of data |
| | stream destined to given tethered device. |

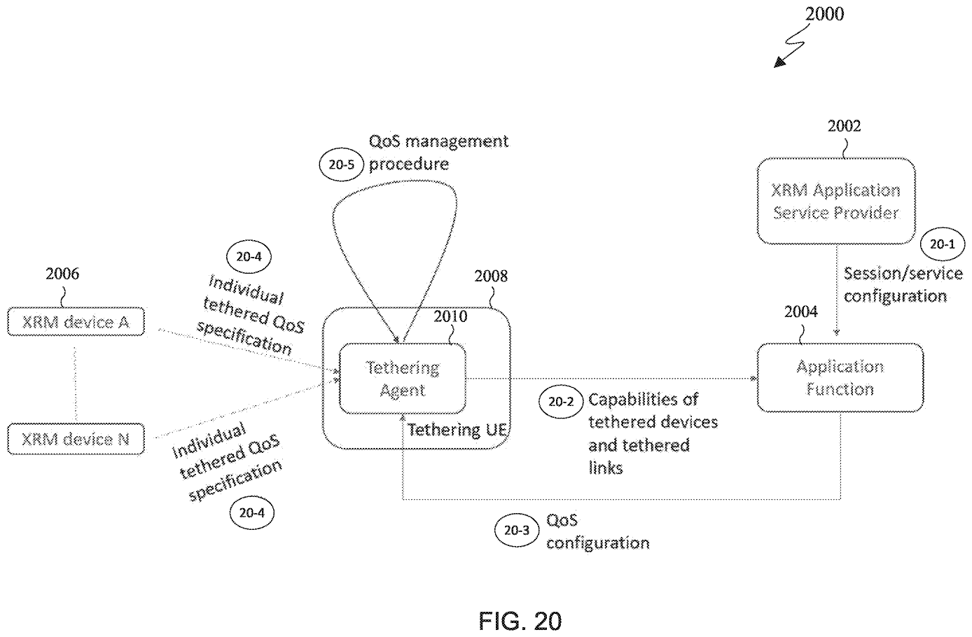

In the embodiment of FIG. 19, the tethering UE collects individual tethered QoS specifications of all tethered devices, prepares the Client Tethered QoS specification, and sends it to the Application Function for synchronization and data management guidance. In an alternative embodiment, instead of the Application Function receiving the Client Tethered QoS specification to perform synchronization and data management decisions, the Application Function may equip the tethering UE to perform the same decisions locally at the UE as shown in FIG. 20.

FIG. 20 illustrates an example procedure for delegation of QoS management to a tethering UE 2000 according to embodiments of the present disclosure. An embodiment of the procedure illustrated in FIG. 20 is for illustration only. One or more of the components illustrated in FIG. 20 may be implemented in specialized circuitry configured to perform the noted functions or one or more of the components may be implemented by one or more processors executing instructions to perform the noted functions. Other embodiments of a procedure for 20 could be used without departing from the scope of this disclosure.

In the example of FIG. 20, the procedure 2000 begins at step 20-1. At step 20-1, an XRM Application Service provider 2002 performs a session and service management at the Application Function 2004 (e.g., similar as described in 3GPP TS 26.501 and TS 26.510)

At step 20-2 the tethering UE 2008 may inform the capabilities of tethered devices 2006 and tether links to the Application Function 2004 as described herein.

At step 20-3, the Application Function 2004 may provide QoS configuration information to manage QoS of data streams of one or more tethered devices 2006 to the tethering UE 2008. By providing this information, the Application Function 2004 is delegating QoS management of tethered device traffic to the UE 2008.

At step 20-4, each XRM tethered device 2006 connected to a tethering UE 2008 may transmit an individual tethered QoS specification to the Tethering Agent 2010 in the UE 2008. The individual tethered QoS specification for each tethered device 2006 and tethered link may be described herein.

At step 20-5, the Tethering Agent 2010 in the UE 2008, upon receiving one or more individual tethered QoS specifications from each of the connected tethered devices 206, performs a QoS management procedure as herein.

The QoS configuration information from the Application Function 2004 helps configure QoS parameters at each of the tethered devices. To facilitate QoS configuration at each of the tethered devices, any of the information from Table 10 may be provided by the Application Function 2004 to the tethering agent 2010 in the UE 2008.

TABLE 10
QoS Configuration Information

| Information Element | Description | |
|---|---|---|
| Packet loss requirement action | Map of requirements for packet loss. Each element in the | |
| map | map is of the form <key, value> pair where key represents | |
| | the identification of tethered device, and value represents | |
| | the requirements for packet loss for data streams destined to | |
| | the given tethered device. The packet loss requirement may | |
| | be expressed in terms of following information: | |
| | Maximum/average packet loss rate allowed for the | |
| | data stream | |
| | Threshold configuration for packet loss rate | |
| | Types of FEC correction to be allowed to recover | |
| | from packet loss | |
| | Action to perform if the observed packet loss rate | |
| | exceeds the given threshold. Following actions may | |
| | be specified if observed packet loss is greater than | |
| | given threshold: | |
| | Continue data delivery | |
| | Pause delivery of data stream for a certain | |
| | period of time. If this is specified, the | |
| | Application Function may also include time | |
| | interval during which the data stream is not | |
| | to be delivered to the tethered device. Upon | |
| | expiry of given time interval, the tethering | |
| | agent is to continue delivering data stream to | |
| | the tethered device. | |
| | Terminate delivery of data stream until | |
| | indicated later to restart delivery of data | |
| | stream | |
| | Instantiate FEC correction methods between | |
| | the UE and tethered device to recover from | |
| | packet loss | |
| Packet delay requirement action | Map of requirements for packet latencies. Each element in | |
| map | the map is of the form <key, value> pair where key | |
| | represents the identification of tethered device, and value | |
| | represents the requirements for packet delay/latency for | |
| | data streams destined to the given tethered device. The | |
| | packet delay requirement may be expressed in terms of | |
| | following information: | |
| | Maximum/average packet delay/latency allowed for | |
| | the data stream | |
| | Threshold configuration for packet delay | |
| | Action to perform if the observed packet delay | |
| | exceeds the given threshold. Following actions may | |
| | be specified if observed packet loss is greater than | |
| | given threshold: | |
| | Continue data delivery | |
| | Pause delivery of data stream for a certain | |
| | period of time. If this is specified, the | |
| | Application Function may also include time | |
| | interval during which the data stream is not | |
| | to be delivered to the tethered device. Upon | |
| | expiry of given time interval, the tethering | |
| | agent is to continue delivering data stream to | |
| | the tethered device. | |
| | Terminate delivery of data stream until | |
| | indicated later to restart delivery of data | |
| | stream | |
| Inter stream delay requirement | Map of requirements of inter stream delays between each | |
| action map | pair of tethered devices. Each member of this map is of the | |
| | form <key, value> pair where in: | |
| | Key represents an object having the following | |
| | information: | |
| | Identification of the first tethered device in a tethered device | |
| | pair | |
| | Identification of the second tethered device in a tethered device pair | |
| | Value represents an object with the following | |
| | information: | |
| | the maximum time delay beyond which synchronization errors are to be perceived. | |
| | Action to perform if the observed packet delay | |
| | exceeds the given threshold. Following | |
| | actions may be specified if observed packet | |
| | loss is greater than given threshold: | |
| | Continue data delivery | |
| | Pause delivery of data stream for a | |
| | certain period of time. If this is | |
| | specified, the Application Function | |
| | may also include time interval during | |
| | which the data stream is not | |
| | delivered to the tethered device. | |
| | Upon expiry of given time interval, | |
| | the tethering agent is to continue | |
| | delivering data stream to the tethered | |
| | device. | |
| | Terminate delivery of data stream | |
| | until indicated later to restart delivery | |
| | of data stream | |
| | When this information is provided by the Application | |
| | Function, the tethering agent in the UE performs the | |
| | following actions: | |
| | a) | Given each member of this map, extract the first and |
| | | second identifications of tethered devices, and the |
| | | corresponding maximum synchronization time delay |
| | | and possible actions values |
| | b) | Check the time instance during which the first |
| | | tethered device received the last packet/frame |
| | | destined to it |
| | c) | Check the time instance during which the second |
| | | tethered device received the last packet/frame |
| | | destined to it |
| | d) | Check if the difference in above time values is |

greater than the maximum synchronization time
delay. If it is greater, perform the action represented
by the Action parameter included in the value field.

| | |
|---|---|
| | The above checks are performed by the tethering agent for |
| | each pair of tethered devices. |
| Bit rate requirement action map | Map of requirements for bit rate. Each element in the map |
| | is of the form <key, value> pair where key represents the |
| | identification of tethered device, and value represents the |
| | requirements for bit rate for data streams destined to the |
| | given tethered device. The bit rate requirement may be |
| | expressed in terms of following information: |
| | Minimum/average bit rate allowed for the data |
| | stream |
| | Threshold configuration for bit rate |
| | Action to perform if the observed bit rate is lower |
| | than the given threshold. Following actions may be |
| | specified if observed bit rate is lower than given |
| | threshold: |
| | Continue data delivery |
| | Pause delivery of data stream for a certain |
| | period of time. If this is specified, the |
| | Application Function may also include time |
| | interval during which the data stream is not |
| | delivered to the tethered device. Upon expiry |
| | of given time interval, the tethering agent is |
| | to continue delivering data stream to the |
| | tethered device. |
| | Terminate delivery of data stream until |
| | indicated later to restart delivery of data |
| | stream |

Although FIG. 20 illustrates one example procedure for delegation of QoS management to a tethering UE 2000, various changes may be made to FIG. 20. For example, while shown as a series of steps, various steps in FIG. 20 could overlap, occur in parallel, occur in a different order, occur any number of times, be omitted, or replaced by other steps.

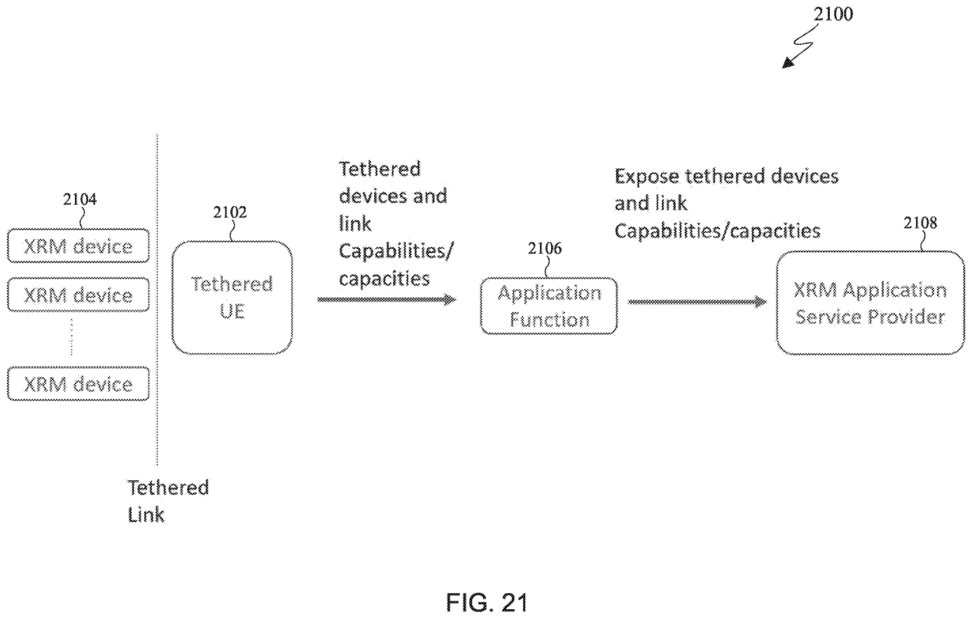

FIG. 21 illustrates an example exposure of capabilities of tethered devices and tethered links to the network 2100 according to embodiments of the present disclosure. The embodiment of exposure of capabilities of tethered devices and tethered links to the network of FIG. 21 is for illustration only. Different embodiments of an exposure of capabilities of tethered devices and tethered links to the network could be used without departing from the scope of this disclosure.

In some embodiments herein, conveying the QoS specification of the tethered devices behind the UE to the network is based on received capabilities/capacities of the devices and the communication links between the UE and tethered devices. In an alternative embodiment, the UE 2102, behind which there may be one or more tethered XRM devices 2104, may inform a network apparatus 2106 (e.g., an Application Function in the core network) about the capabilities of the following:
Capabilities of each of the one or more tethered XRM devices 2104
   Type of tethering device
   Device capabilities (features, processing etc.)
Capabilities/capacities of the communication link between the tethered devices 2104 and the UE 2102. For example, the UE 2102 may inform the Application Function 2106 about
   Link bandwidth and/or link throughput
   Link bit rate (min/max/mean/aggregate)
   Link latency (min/max/avg)
   Link packet loss (min/max/avg)
   Jitter (min/max/avg)
   Etc.

The network apparatus entity 2106 (i.e. the Application Function) may in turn expose the capabilities of the XRM devices 2104 and the communication links between the UE 2102 and the tethered devices 2104 to the XRM Application Service Provider 2108 based on operator and user preferences.

Although FIG. 21 illustrates one example exposure of capabilities of tethered devices and tethered links to the network 2100, various changes may be made to FIG. 21. For example, various changes to the number of tethered devices could be made, etc., according to particular needs.

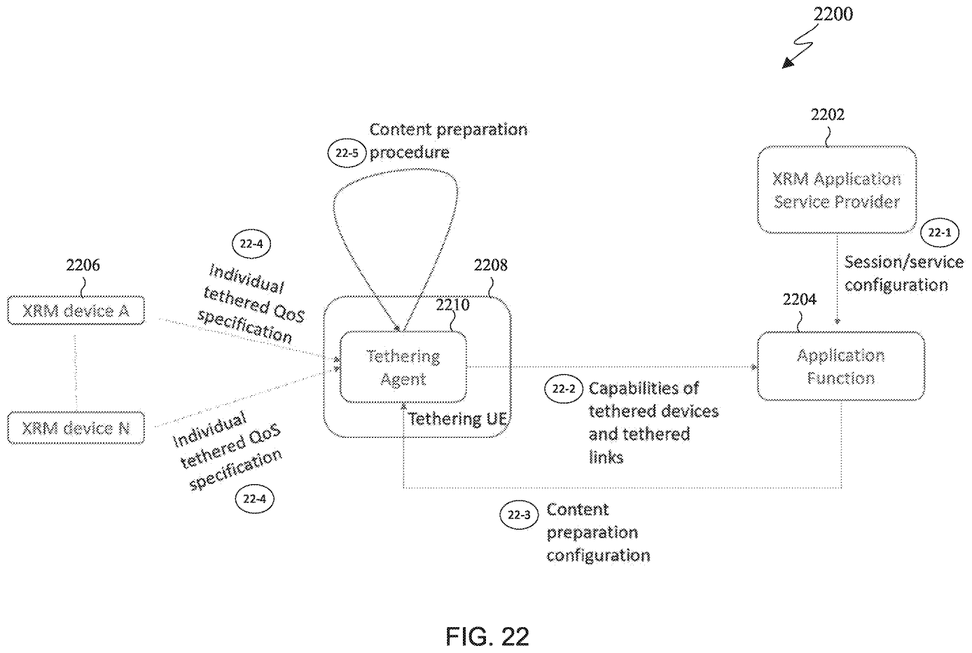

In the embodiment of FIG. 19, a tethering UE collects individual tethered QoS specifications of all tethered devices, prepares the Client Tethered QoS specification, and sends it to the Application Function for synchronization and data management guidance. In an alternative embodiment, the Application Function may equip the tethering UE on the content preparation for one or more tethered devices as shown in FIG. 22.

FIG. 22 illustrates an example procedure for delegation of content preparation to a tethering UE 2200 according to embodiments of the present disclosure. An embodiment of the procedure illustrated in FIG. 22 is for illustration only. One or more of the components illustrated in FIG. 22 may be implemented in specialized circuitry configured to perform the noted functions or one or more of the components may be implemented by one or more processors executing instructions to perform the noted functions. Other embodiments of a procedure for delegation of content preparation to a tethering UE could be used without departing from the scope of this disclosure.

In the example of FIG. 22, the procedure 2200 begins at step 22-1. At step 22-1, an XRM Application Service provider 2202 performs a session and service management at the Application Function 2204 (e.g., similar as described in 3GPP TS 26.501 and TS 26.510). The XRM Application Service Provider 2202 may provision a content preparation template to instruct how the content is to be processed, updated, and distributed to the UE 2210.

In some embodiments, the type of processing that needs to be performed to the media streams before they are streamed to the end user devices can include the additional content preparation information element of Table 11 when the service details are provisioned in to the Application Function.

TABLE 11
Content Preparation Information Element

| Information Element | Type | Description |
|---|---|---|
| Offload_content_prepara- | Boolean | Provisions that the Application Function facilitate |
| tion_to_UE | | that content preparation details be offloaded to |
| | | the UE according to the procedures described in |
| | | this disclosure. |
| | | When this option is specified by the Application |
| | | Service Provider for an XRM service, the |
| | | Application Service Provider intends that the |
| | | Application Function transfer content preparation |
| | | functionality to the UE as described in this |
| | | embodiment. |

At step 22-2, the tethering UE 2208 may inform the capabilities of tethered devices 2206 and tether links to the Application Function 2204 as described in herein. The capabilities of the one or more tethered devices 2206 connected to the UE 2208 may influence the type of content preparation that happens to the tethered device content.

At step 22-3, the Application Function 2204 may provide content preparation configuration information to manage content preparation of data streams of one or more tethered devices 2206 to the tethering UE 2208. By providing this information, the Application Function 2204 is delegating content preparation of media streams destined to one or more tethered devices to the UE 2208.

At step 22-4, each XRM tethered device 2206 connected to a tethering UE 2208 may transmit individual tethered QoS specifications to the Tethering Agent 2210 in the UE 2208. The individual tethered QoS specifications for each tethered device and tethered link may be as described herein.

At step 22-5, the Tethering Agent 2210 in the UE 2208, upon receiving one or more individual tethered QoS specifications from each of the connected tethered devices 2206, performs the content preparation procedure based on the configured content preparation configuration as described herein.

The content preparation configuration information from the Application Function 2204 helps process the content before it is sent to the connected tethered devices 2206. In some embodiments, at least some of the information from Table 12 can be provided by the Application Function 2204 as part of the content preparation configuration information.

TABLE 12
Content Preparation Configuration Information

| Information Element | Description |
|---|---|
| Execution_environment_details | Details of the execution environment where the content |
| | preparation task is to execute. This may include the |
| | following information |
| | Trust_space: Trusted space configuration where to |
| | execute the required processing |
| | Security_configuration: Configuration of security on |
| | the trust space. This may include details such as |
| | following |
| | Port_forwarding_rules: Port forwarding rule |
| | configuration |
| | Key_retrieval_server: Server to retrieve the |
| | content decryption key from |
| | Access_token: Access token to use to |
| | request downloading of content decryption |
| | key |
| Execution_script_details | Details of the execution script to be executed in the above |
| | execution environment for required content processing. |
| | This may include the following information |
| | Execution_script: Processing script to run in the |
| | secure trust space |
| | Execution_script_URL: URL of the execution script |
| | that is to be downloaded into the trusted execution |
| | space to run the processing |
| | Stream_information: Information of media stream to |
| | which the given processing is to be applied on. |
| generate_new_media | Indicates whether the UE 2208 is to generate new media as |
| | a result of processing the incoming media stream. |
| | When the UE 2208 receives this configuration option from |
| | Application Function 2204, it executes the given content |
| | preparation script in the given execution environment to |
| | generate new media streams. The Application Function |
| | 2204, may for example, decide to terminate streaming of |
| | one or more content type media streams from the network |
| | to the UE, and instead intends the UE generate those media |
| | streams to one or more of the tethered devices. |
| QoS_criteria | QoS criteria when to run the given content preparation at |
| | the UE 2208. This may be expressed in the form of <key, |
| | value> pair, where in key represents the identification of |
| | tethered device, and value is an object with the following |
| | information: |
| | Packet loss threshold: Packet loss threshold above |
| | which the content preparation in the UE is to be |
| | applied. |
| | When this option is specified, the procedure for |
| | executing content preparation in the UE 2208 |
| | continues as long as the current packet loss with the |
| | given tethered device is higher than the threshold |
| | configured in this parameter |
| | Packet delay threshold: Packet delay threshold |
| | above which the content preparation in the UE is to |
| | be applied. |
| | When this option is specified, the procedure for |
| | executing content preparation in the UE 2208 |
| | continues as long as the current packet delay with |
| | the given tethered device is higher than the |
| | threshold configured in this parameter |
| | Bit rate threshold: Bit rate threshold below which |
| | the content preparation in the UE is to be applied. |
| | When this option is specified, the procedure for |
| | executing content preparation in the UE |
| | 2208continues as long as the current bit rate with the |
| | given tethered device is lower than the threshold |
| | configured in this parameter |
| | Packet Jitter threshold: Packet Jitter threshold above |
| | which the content preparation in the UE is to be |
| | applied. |
| | When this option is specified, the procedure for |
| | executing content preparation in the UE 2208 |
| | continues as long as the current packet jitter for the |
| | given tethered device is higher than the threshold |
| | configured in this parameter |
| | The UE 2208 executes the given execution script, and |
| | optionally generates new media, when at least one of the |
| | above conditions satisfies. |
| | Alternatively, if none of the above conditions apply in the |
| | current scenario, the UE receives the media streams directly |
| | from the Application Server, and no processing is |
| | performed on the UE. |
| Processing_time | Amount of time to run the content processing on the UE |
| | 2208. When UE 2208 receives this information, it starts a |
| | timer with this time value, and performs content processing |
| | as described in this embodiment. When the timer expires, |
| | the UE 2208 ceases to execute the processing script, and |
| | instead waits for the Application Function instructions. |
| | Optionally, the Application Function may send an update to |
| | the processing instructions and processing time described in |
| | this embodiment, and the UE 2208 resets the timer when it |
| | receives a new processing time value. |

Although FIG. 22 illustrates one example procedure for delegation of content preparation to a tethering UE 2200, various changes may be made to FIG. 22. For example, while shown as a series of steps, various steps in FIG. 22 could overlap, occur in parallel, occur in a different order, occur any number of times, be omitted, or replaced by other steps.

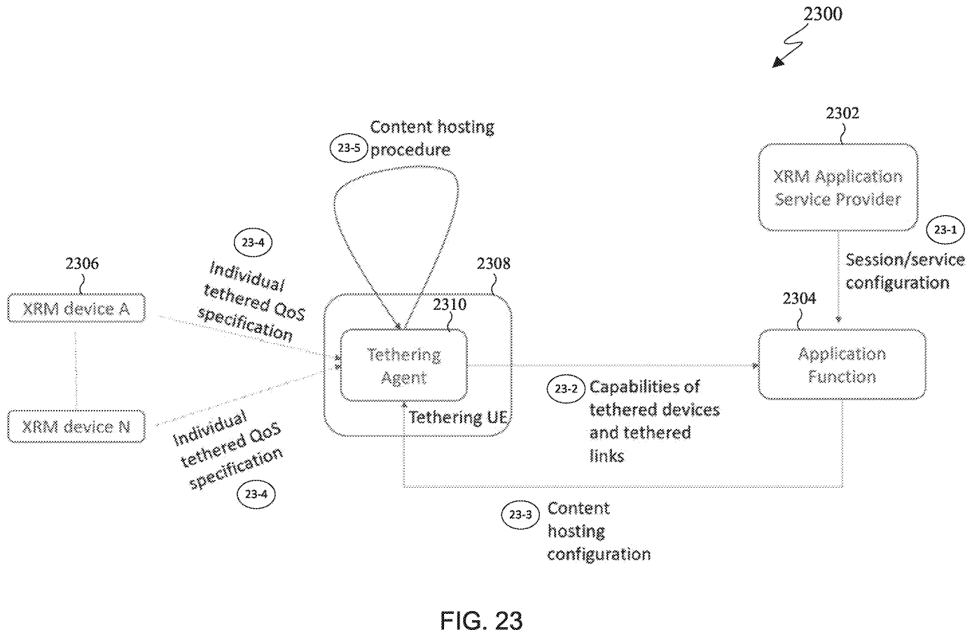

In some of the embodiments describe herein, a tethering UE collects individual tethered QoS specifications of all tethered devices, prepares the Client Tethered QoS specification, and sends it to the Application Function for synchronization and data management guidance. In an alternative embodiment, the Application Function may provision the UE with content hosting capabilities as shown in FIG. 23.

FIG. 23 illustrates an example procedure for content hosting of media data of different tethered devices 2300 according to embodiments of the present disclosure. An embodiment of the procedure illustrated in FIG. 23 is for illustration only. One or more of the components illustrated in FIG. 23 may be implemented in specialized circuitry configured to perform the noted functions or one or more of the components may be implemented by one or more processors executing instructions to perform the noted functions. Other embodiments of a procedure for content hosting of media data of different tethered devices could be used without departing from the scope of this disclosure.

In the example of FIG. 23, the procedure 2300 begins at step 23-1. At step 23-1, an XRM Application Service provider 2302 performs a session and service management at the Application Function 2304 (e.g., similar as described in 3GPP TS 26.501 and TS 26.510). The XRM Application Service Provider 2302 may provision a content hosting configuration to instruct how the content is to be hosted for distribution to one or more UEs.

In some embodiments, content hosting capacity that needs to be provisioned in the network before the media data destined for one or more tethered devices 2306 in the UE 2308 are sent to the UE 208 includes the additional content hosting information element of Table 13 when the service details are provisioned in to the Application Function.

TABLE 13
Content hosting information element

| Information Element | Type | Description |
|---|---|---|
| Offload_content_hoting_to_UE | Boolean | Provisions that the Application Function facilitate |
| | | that content hosting for one or more tethered |
| | | devices be offloaded to the UE according to the |
| | | procedures described herein. |
| | | When this option is specified by the Application |
| | | Service Provider for an XRM service, the |
| | | Application Service Provider intends that the |
| | | Application Function transfer content hosting |
| | | functionality to the UE as described herein. |

As step 23-2, the tethering UE 2308 may inform the capabilities of tethered devices 2306 and tether links to the Application Function 2304 as described herein. The capabilities of one or more tethered devices 2306 connected to the UE 2308 may influence the type of content hosting that happens to the tethered device content.

At step 23-3, the Application Function 2304 may provide content hosting configuration information to manage content of data streams of one or more tethered devices 2306 to the tethering UE 2308. By providing this information, the Application Function 2304 is delegating content hosting of media streams destined to one or more tethered devices 2306 of the UE 2308 to the UE 2308.

At step 23-4, each XRM tethered device 2306 connected to a tethering UE 2308 may transmit individual tethered QoS specifications to the Tethering Agent 2310 in the UE. The individual tethered QoS specification for each tethered device and tethered link 2310 can be as described herein.

At step 23-4, the Tethering Agent 2310 in the UE 2308, upon receiving one or more individual tethered QoS specifications from each of the connected tethered devices 2306, performs the content hosting procedure based on the configured content hosting configuration as described herein.

At step 23-5, the content hosting configuration information from the Application Function 2304 helps host the content in the UE 2308 before it is sent to the connected tethered devices 2306. At least some of the following information can provided by the Application Function 2304 as part of the content hosting configuration information.

TABLE 14
Content configuration information.

| Information Element | Description |
|---|---|
| Content map | Map of content for one or more tethered devices to be |
| | hosted in the UE. Each entry in the map is of the form <key, |
| | value> pair where in key represents the identification of |
| | tethered device, and value is a map <k, v> where: |
| | ‘k’ represents a unique content encoding identifier |
| | ‘v’ is an object with the following information: |
| | Content type: Type of content for the media data |
| | Content metadata: Metadata about the content |
| | Stream information: Information to access the media |
| | stream content related to this content type and content |
| | metadata |
| | One or more different types of content for the same media |
| | data and for the same tethered device may be sent to the UE |
| | for hosting. For example, different types of media content |
| | could be any of: |
| | Content resolution: Type 4K, 2K, HD etc. |
| | Content bit rate: Bit rate of media content |
| | Codec info: Information about codec for the content |
| | Different type of media content corresponding to different |
| | media adaptations and different representations specified in |
| | IOS/IEC 23009 MPEG DASH could be sent to the UE for |
| | hosting in the UE for content destined to each tethered |
| | device based on the description in this embodiment. |
| | With this facility, the UE is sent all the different types of |
| | media content that help in rate adaptation at the UE. This is |
| | carried out separately for media data destined to each of the |
| | tethered devices. |
| — | QoS criteria to decide which version of the hosted media |
| | content to send to the tethered device. This may be |
| | expressed in the form of <key, value> pair, where in key |
| | represents the identification of tethered device, and value is |
| | a collection of objects where each object has the following |
| | information: |
| | Parameter name: Name of the QoS parameter. Any |
| | of the QoS parameters such as packet loss, packet |
| | delay, packet jitter, bit rate etc. could be indicated in |
| | this parameter name |
| | Parameter threshold: Threshold against which the |
| | current value of the QoS parameter at the UE given |
| | above is to be compared with |
| | Media description: Id of the content encoding |
| | identifier described in the previous content map |
| | When the UE receives this information from the |
| | Application Function, it helps UE perform rate adaptation at |
| | the UE for one or more tethered devices. |

In some embodiments, the rate adaptation at the UE 2308 for each of the tethered devices 2306 can be performed as follows:
1. UE 2308 receives the above content hosting configuration information with different media content types for each of the tethered devices 2308 from Application Function 2304 or Application Server 2302.
2. UE 2308 checks the current QoS conditions for data streams destined for each tethered device. The QoS conditions for different QoS parameters such as packet loss, packet delay, packet jitter, bit rate etc. could be checked for each tethered device.
3. Based on the current observed QoS conditions, and the received content adaptation map, the UE 2308 can extract the unique media content identifier to send to the tethered device 2306 based on current QoS conditions of the tethered device 2306.
4. Based on the extracted unique content encoding identifier, UE 2308 extracts the information of media stream it needs to send to the tethered device 2306. The UE 2308 uses this information to send the rate adapted media stream content to the tethered device 2306.
5. The UE 2308 constantly checks the current QoS conditions to check if a different version of media content is to be sent to the tethered devices
6. The Application Function 2304 may provide an updated content hosting configuration to change the type of media content and QoS criteria to be sent to change how media content is sent to the tethered device 2306 from the hosted content on the UE 2308.

Optionally, each of the tethered devices 2306 may request content based on its own content adaptation algorithm. In this case, the UE 2308 may serve the content requested by the tethered device 2306.

Although FIG. 23 illustrates one example procedure for content hosting of media data of different tethered devices 2300, various changes may be made to FIG. 23. For example, while shown as a series of steps, various steps in FIG. 23 could overlap, occur in parallel, occur in a different order, occur any number of times, be omitted, or replaced by other steps.

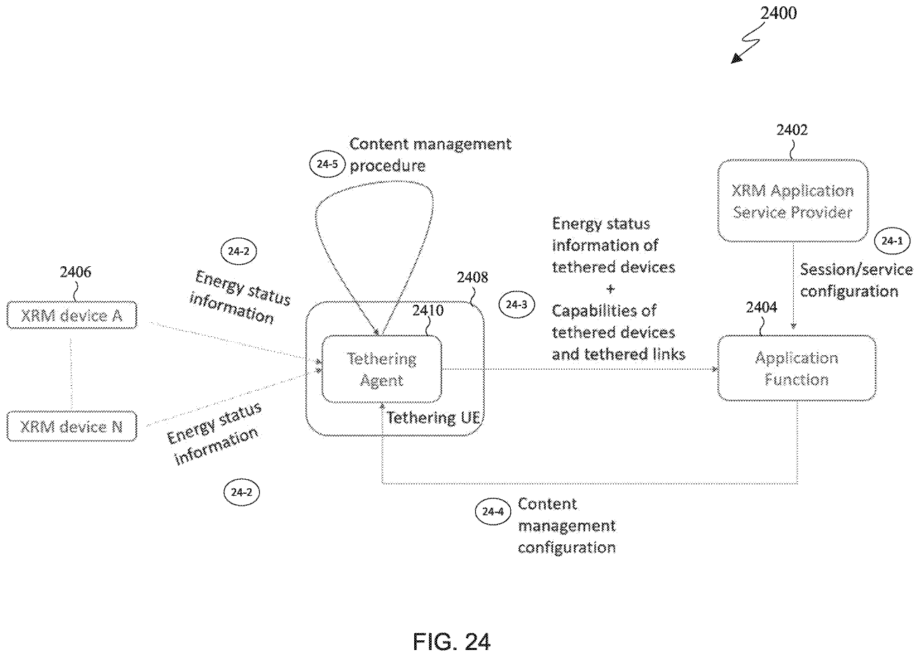

In some of the embodiments described herein, the tethering UE collects individual tethered QoS specifications of all tethered devices, prepares the Client Tethered QoS specification, and sends it to the Application Function for synchronization and data management guidance. In an alternative embodiment, the Application Function may provide content management guidance based on energy consumption at the UE and the tethered devices as described in FIG. 24.

FIG. 24 illustrates an example procedure for content management based on the energy status of tethered devices 2400 according to embodiments of the present disclosure. An embodiment of the procedure illustrated in FIG. 24 is for illustration only. One or more of the components illustrated in FIG. 24 may be implemented in specialized circuitry configured to perform the noted functions or one or more of the components may be implemented by one or more processors executing instructions to perform the noted functions. Other embodiments of a procedure for content management based on the energy status of tethered devices could be used without departing from the scope of this disclosure.

In the example of FIG. 24, the procedure 2400 begins at step 24-1. At step 24-1, an XRM Application Service provider 2402 performs a session and service management at the Application Function 2404 (e.g., similar as described 3GPP in TS 26.501 and TS 26.510.

At step 24-2, each XRM tethered device 2406 connected to the tethering UE 2408 may transmit its current energy status information to the Tethering Agent 2410 in the UE 2408.

The energy status information of each tethering device 2406 may include at least some of the information from Table 15.

TABLE 15
Current energy status information

| Information Element | Description |
|---|---|
| battery_status | Current battery status of the tethered device |
| energy_source | Type of energy source being used at the tethered |
| | device |
| average_battery_life | Average battery life of the tethered device |

At step 24-3, the tethering agent 2410 in the UE 2408 collects the energy status information of all the tethered devices 2406 and sends it to the Application Function 2404 along with the capabilities of each of those tethered devices 2406 and the tethered links. The capabilities of tethered devices 2406 and tethered links can be as described herein.

At step 24-4, the Application Function 2404, based on the received energy status information and the detailed information about capabilities of tethered devices 2406 and tethered links provide content management configuration to the UE 2408. The details of the content management configuration can be as described herein.

At step 25-5 The tethering agent 2410 in the UE 2408, or the UE 2408 itself, performs content management procedure as described in this embodiment.

As part of this procedure, the tethering UE 2408 may also optionally send the collection of individual tethered QoS specifications, or the generated Client tethered QoS specification described earlier, to the Application Function 2404.

The content management configuration information helps UE 2404 regulate content to one or more tethered devices 2406. To facilitate content management to tethered devices at the UE, as least some of the information of Table 16 may be provided as part of the content management configuration.

TABLE 16

| Information Element | Description |
|---|---|
| Tethered device content management | Map providing content management notification. Each |
| notification map | member of the map is of the form <key, value> pair |
| | where in key represents the identification of the tethered |
| | device, and value represents a notification about the |
| | action that is to be undertaken. Following notification |
| | types may be provided as part of the value field. For |
| | each notification type, the Application Function may |
| | interact with the Application Server to manage delivery |
| | of data streams to one or more of the tethered devices |
| | connected to the tethering UE |
| | Continue data delivery notification: Continue |
| | data delivery given the current energy status of |
| | the tethered device. |
| | In this option, Application Function does not |
| | change the current behavior of content delivery |
| | to the tethering UE. Therefore, no interaction |
| | with the Application Server is performed. |
| | Paused delivery of content stream notification: |
| | Pause delivery of content for a certain period of |
| | time to the given tethered device. If this is |
| | specified, the Application Function may also |
| | include time interval in the notification |
| | information during which the content is not |
| | delivered to the tethered device. Upon expiry of |
| | given time interval, the tethering UE may |
| | receive content destined to the tethered device. |
| | When this notification is sent out, the |
| | Application Function interacts with the |
| | Application Server to pause delivery of content |
| | destined to given tethered device for the |
| | specified time interval. |
| | Notification to terminate delivery of content: |
| | Terminate delivery of content until decided later |
| | to restart delivery of content to the tethered |
| | device. |
| | When this notification is sent out, the |
| | Application Function interacts with the |
| | Application Server to terminate delivery of |
| | content destined to given tethered device. |

Although FIG. 24 illustrates one example procedure or content management based on the energy status of tethered devices 2400, various changes may be made to FIG. 24. For example, while shown as a series of steps, various steps in FIG. 24 could overlap, occur in parallel, occur in a different order, occur any number of times, be omitted, or replaced by other steps.

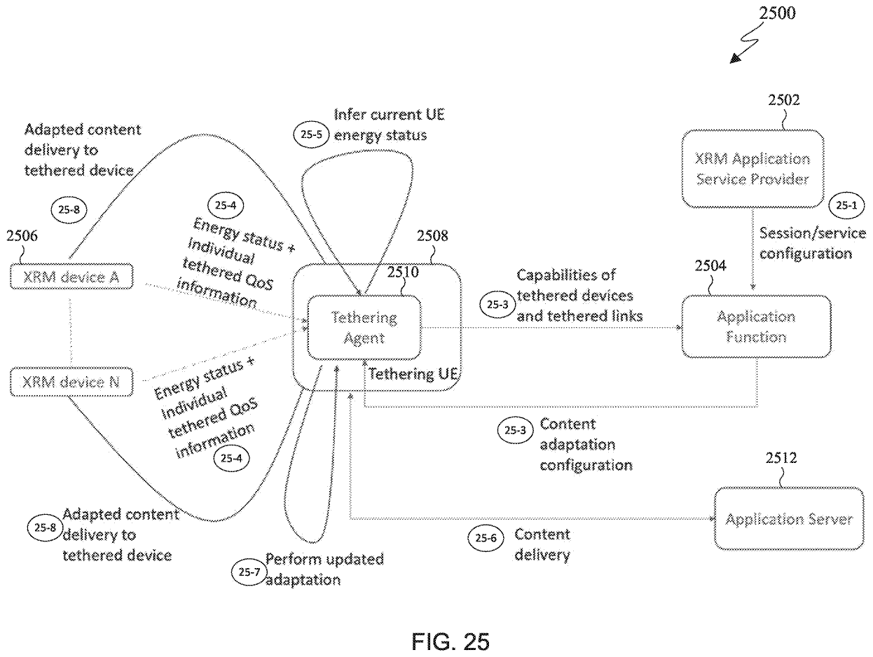

In some embodiments, content adaptation can based on an energy status of tethered devices and UE assistance, as shown in FIG. 25.

FIG. 25 illustrates an example procedure for UE assisted content adaptation based on the energy status of tethered devices 2500 according to embodiments of the present disclosure. An embodiment of the procedure illustrated in FIG. 25 is for illustration only. One or more of the components illustrated in FIG. 25 may be implemented in specialized circuitry configured to perform the noted functions or one or more of the components may be implemented by one or more processors executing instructions to perform the noted functions. Other embodiments of a procedure for UE assisted content adaptation based on the energy status of tethered devices could be used without departing from the scope of this disclosure.

In the example of FIG. 25, the procedure 2500 begins at step 25-1. At step 25-1, an XRM Application Service provider 2502 performs a session and service management at the Application Function 2504 (e.g., similar as described in 3GPP TS 26.501 and TS 26.510).

At step 25-2, the tethering agent 2510 in the UE 2508 forwards the capabilities of each of the tethered devices 2506 and the tethered links to the Application Function 2504. The capabilities of tethered devices 2506 and tethered links maybe as described herein.

At step 25-3, the Application Function 2504, based on the received capabilities of tethered devices 2506 and tethered links, provides a content adaptation configuration to the UE 2508 which the UE 2508 can use for content adaptation to the tethered devices 2506 based on the current tethered device energy status. The details of the content adaptation configuration may be as described herein.

At step 25-4, each XRM tethered device 2506 connected to the tethering UE 2508 may transmit its current energy status information along with its current individual tethered QoS specification to the tethering agent 2510 in the UE 2508. The energy status information and individual tethered QoS specification information may be similar as described herein.

At step 25-5, the tethering agent 2510 also checks the current energy status of the UE 2508. The energy status of the UE 2508 may have similar parameters as that of the tethered device 2506 as described herein.

At step 25-6, the UE 2508 performs content retrieval from the Application Server 2512. In some embodiments, the UE 2508 may receive a limited set of content adaptations/representations (for example, similar as described in ISO/IEC 23009: MPEG DASH)

At step 25-7, the UE 2508 performs content adaptation for a tethered device 2506 as described herein.

At step 25-8, the adapted content is sent to the tethered device 2506 for consumption.

The content adaptation configuration from the Application function 2504 provided in step 25-3 facilitates preparation of appropriate content encoding to the tethered device 2506 if the content retrieved from the Application server 2512 does not have the desired quality that is appropriate based on the current energy status of the tethered device 2506. At least some of the information form Table 17 may be included in the content adaptation configuration.

TABLE 17
Content Adaptation Configuration Information

| Information Element | Description |
|---|---|
| prepare_content_adaptation | Boolean variable indicating that the UE is to prepare |
| | appropriate content based on current energy status of |
| | tethered device and the current energy status of the |
| | UE |
| Execution_environment_details | Details of the execution environment where the |
| | content adaptation task is to execute. This may |
| | include the following information |
| | Trust_space: Trusted space configuration |
| | where to execute the required processing |
| | Security_configuration: Configuration of |
| | security on the trust space. This may include |
| | details such as following |
| | Port_forwarding_rules: Port |
| | forwarding rule configuration |
| | Key_retrieval_server: Server to |
| | retrieve the content decryption key |
| | from |
| | Access_token: Access token to use to |
| | request downloading of content |
| | decryption key |
| Execution_script_details | Details of the content adaptation script to be |
| | executed in the above execution environment for |
| | required content adaptation. This may include the |
| | following information |
| | Execution_script: Processing script to run in |
| | the secure trust space |
| | Execution_script_URL: URL of the |
| | execution script that is to be downloaded into |
| | the trusted execution space to run the |
| | processing |
| content_server | URL of the content Application server to optionally |
| | retrieve additional content if necessary |

Although FIG. 25 illustrates one example procedure for UE assisted content adaptation based on the energy status of tethered devices 2500, various changes may be made to FIG. 25. For example, while shown as a series of steps, various steps in FIG. 25 could overlap, occur in parallel, occur in a different order, occur any number of times, be omitted, or replaced by other steps.

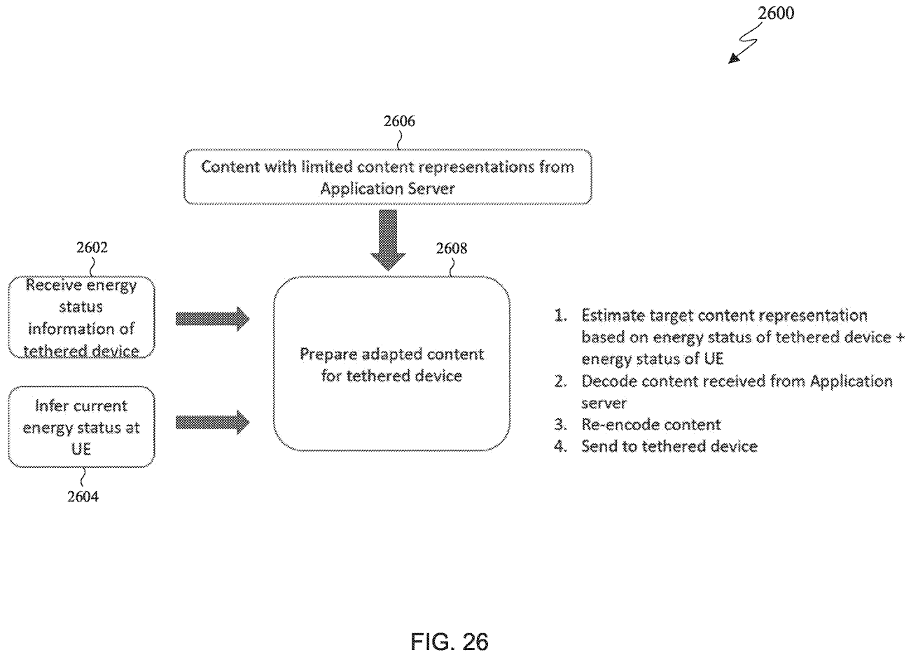

In some embodiments, when a UE receives the content adaptation configuration information of Table 17, it may perform the content adaptation for each tethered device as shown in FIG. 26

FIG. 26 illustrates another example procedure for content management based on the energy status of tethered devices 2600 according to embodiments of the present disclosure. An embodiment of the procedure illustrated in FIG. 26 is for illustration only. One or more of the components illustrated in FIG. 26 may be implemented in specialized circuitry configured to perform the noted functions or one or more of the components may be implemented by one or more processors executing instructions to perform the noted functions. Other embodiments of a procedure for content management based on the energy status of tethered devices could be used without departing from the scope of this disclosure.

In the example of FIG. 26, the procedure 2600 begins at step 2602. At step 2602, a UE (such as UE 2508) receive energy status information of a tethered device, or optionally in some embodiments, uses applications installed on the UE to infer the energy status of the tethered device.

At step 2604, the UE infers the current energy status of the UE.

At step 2606, the UE receives content with limited representations from an Application server (e.g., 512 kbps, 8 mpbs).

At step 2608, the UE prepares adapted content for the tethered device. This may include the UE:
1. Estimating the target content quality based on the current energy status of tethered device, and the energy status of UE (e.g., 1 mbps which is not available from content retrieved from Application Server);
2. Decoding content retrieved from Application server (preferably the representation that is closer in quality to the estimated target);
3. Re-encoding the content to the target content quality; and
4. delivering the content to the tethered device.

Although FIG. 26 illustrates one example procedure for content management based on the energy status of tethered devices 2600, various changes may be made to FIG. 26. For example, while shown as a series of steps, various steps in FIG. 26 could overlap, occur in parallel, occur in a different order, occur any number of times, be omitted, or replaced by other steps.

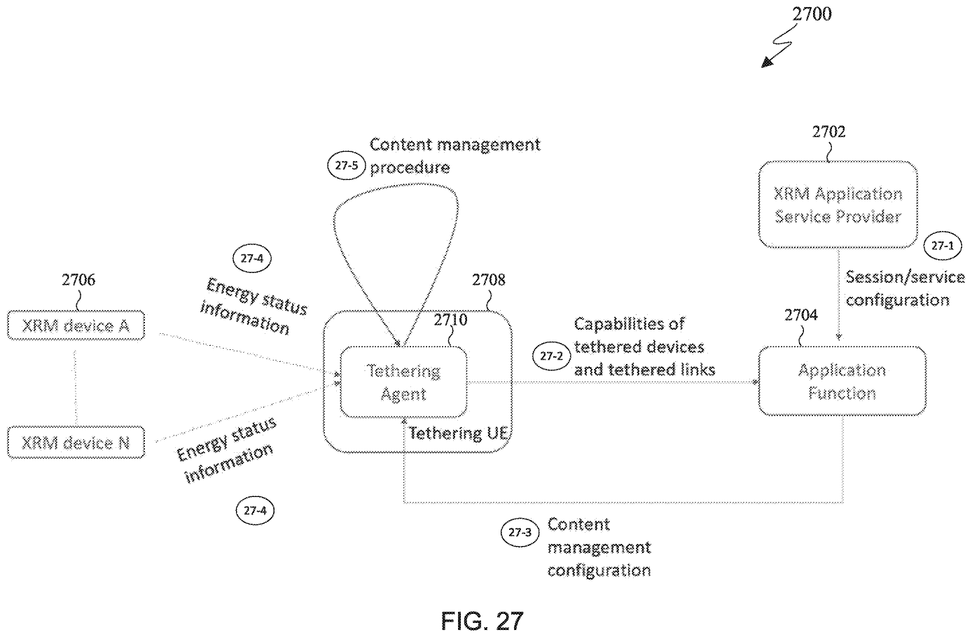

In the embodiment of FIG. 25, content management in the tethering UE is based on a content management configuration from the Application Function that was generated based on reception of energy status information of each of the tethered devices. In an alternative embodiment, more control for content management can be provided by the Application Function to the UE (i.e., the responsibility for content management is delegated to the UE) as shown in FIG. 27.

As part of this alternative procedure for content management based on energy status information of tethered devices, the Application Function sends a content management configuration information that helps UE decide what type of content, if any, to be delivered to one or more tethered devices based on their current energy status information.

FIG. 27 illustrates another example procedure for content management based on the energy status of tethered devices 2700 according to embodiments of the present disclosure. An embodiment of the procedure illustrated in FIG. 27 is for illustration only. One or more of the components illustrated in FIG. 27 may be implemented in specialized circuitry configured to perform the noted functions or one or more of the components may be implemented by one or more processors executing instructions to perform the noted functions. Other embodiments of a procedure for content management based on the energy status of tethered devices could be used without departing from the scope of this disclosure.

In the example of FIG. 27, the procedure 2700 begins at step 27-1. At step 27-1, an XRM Application Service provider 2702 performs a session and service management at the Application Function 2704 (e.g., similar as described in 3GPP TS 26.501 and TS 26.510).

At step 27-2, the tethering agent 2710 in the UE 2708 forwards the capabilities of each of the tethered devices 2706 and the tethered links to the Application Function 2704. The capabilities of tethered devices 2706 and tethered links can be as described herein.

At step 27-3, the Application Function 2704, based on the received capabilities of tethered devices 2706 and tethered links, provides a content management configuration to the UE 2708 which the UE 2708 can use to regulate content to the tethered devices based on the current tethered device energy status. The details of the content management configuration can be as described herein.

At step 27-4, each tethered device 2706 forwards its energy status information to the UE 2708. Optionally, the UE 2708 may have mechanisms in place to read the current energy status of the tethered devices 2706.

At step 27-5, the tethering agent 2710 in the UE 2708, or the UE 2708 itself, performs a content management procedure based on the current energy status of the tethered 2706 devices as described herein.

As part of this procedure, the tethering UE 2708 may also optionally send the collection of individual tethered QoS specifications, or the generated Client tethered QoS specification described herein to the Application Function 2704.

The content management configuration information helps UE 2708 regulate content to one or more tethered devices 2706 based on their current energy status. The information from Table 18 be provided as part of the content management configuration from the Application Function 2704 to the tethering UE 2708.

TABLE 18
Content Management Configuration Information

| Information Element | Description |
|---|---|
| energy action map | Map of actions based on current energy |
| | consumption/availability at the tethered device. Each |
| | element in the map is of the form <key, value> pair |
| | where |
| | key represents the identification of tethered |
| | device, |
| | value represents a collection of objects |
| | Each object in the above collection has the following |
| | information: |
| | Min energy availability: Minimum energy |
| | availability in a given range |
| | Max energy availability: Max energy availability |
| | in a given range |
| | Action to perform if the current energy |
| | availability of the tethered device falls in |
| | between the above min and max energy |
| | availability values. Following actions may be |
| | specified: |
| | Continue data delivery |
| | Pause delivery of content for a certain |
| | period of time. If this is specified, the |
| | Application Function may also include |
| | time interval during which the content is |
| | not to be delivered to the tethered device. |
| | Upon expiry of given time interval, the |
| | tethering agent is to continue delivering |
| | data stream to the tethered device. |
| | Terminate delivery of content until |
| | indicated later to restart delivery of data |
| | stream |
| | Lower service quality: Reduce the |
| | quality of content delivered to the |
| | tethered device. |
| | If this option is indicated by the |
| | Application Function to the tethering |
| | UE, the Application Function may also |
| | include the following details for this |
| | option: |
| | Parameter: Name of the |
| | parameter of content |
| | From_value: The current quality |
| | of content that to has be reduced |
| | from |
| | To_value: The quality of content |
| | to be reduced to |
| | Time: Amount of time to go to |
| | the reduced service quality |
| | Example: Parameter: bit rate |
| | From_quality: 2 mbps |
| | To_quality: 512 kbps |
| | Indicates that the video bit rate is to |
| | be reduced from 2 mbps to 512 kbps |
| | if the current energy availability in |
| | the tethered device is in between the |
| | above range |
| | Any of the following parameters may |
| | be provided in the above quality |
| | reduction configuration: |
| | Bit rate |
| | Codec type |
| | Content resolution |
| | Any of the content metadata |
| | specified in ISO/IEC MPEG |
| | DASH standard |

When the UE 2708 receives this configuration information, it checks the current energy status (energy consumption/availability) of the tethered device 2706, extracts the object of which max and min energy values surround the current energy status information of the tethered device 2706, checks for the recommended action, and performs the recommended action.

Although FIG. 27 illustrates one example procedure for content management based on the energy status of tethered devices 2700, various changes may be made to FIG. 27. For example, while shown as a series of steps, various steps in FIG. 27 could overlap, occur in parallel, occur in a different order, occur any number of times, be omitted, or replaced by other steps.

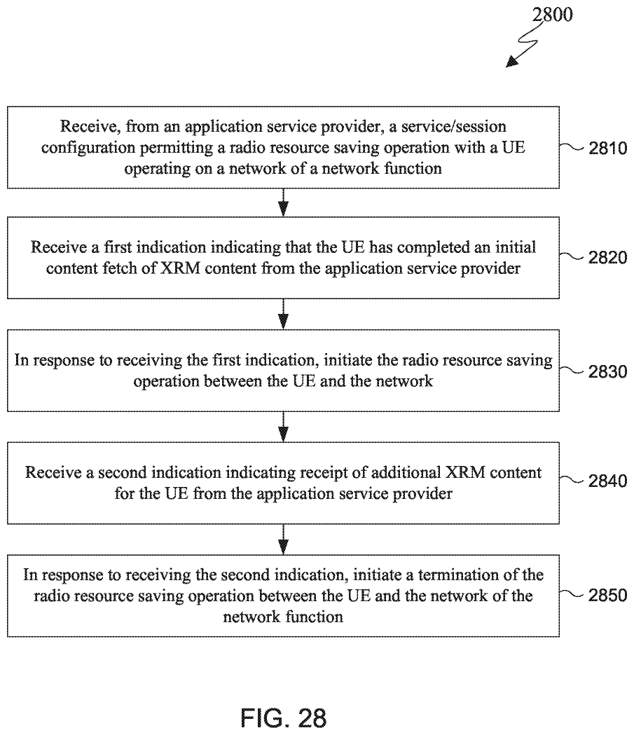

FIG. 28 illustrates an example method for resource allocation and management of XRM services 2800 according to embodiments of the present disclosure. An embodiment of the method illustrated in FIG. 28 is for illustration only. One or more of the components illustrated in FIG. 28 may be implemented in specialized circuitry configured to perform the noted functions or one or more of the components may be implemented by one or more processors executing instructions to perform the noted functions. Other embodiments of a method for resource allocation and management of XRM services could be used without departing from the scope of this disclosure.

In the example of FIG. 28, method 2800 begins at step 2810. At step 2810, an electronic device, for example operating as a network function (such as the AF 804 of FIG. 8 or another network function), receives from an application service provider (such as application service provider 802 of FIG. 8), a service/session configuration permitting a radio resource saving operation with a UE (such as UE 814 of FIG. 8) operating on a network of the network function.

At step 2820, the electronic device receives a first indication that the UE has completed an initial content fetch of XRM content from the application service provider.

At step 2830, in response to receiving the first indication, the electronic devices initiates the radio resource saving operation between the UE and the network.

At step 2840, the electronic device receives a second indication indicating receipt of additional XRM content for the UE from the application service provider.

At step 2850, in response to receiving the second indication, the electronic device initiates a termination of the radio resource saving operation between the UE and the network of the network function.

In some embodiments, the electronic device may also receive or determine burst configuration information for the network. In embodiments such as these, after receiving the second indication, the electronic device may observe an application burst based on the burst configuration information, and in response to observing the application burst, initiate an allocation of radio resources that permits the UE to continuously receive XRM content during the application burst. The burst configuration information can include at least one of burst_periodicity_post_initial_content_fetch, burst_samples, burst interval, burst_size, service_burst_bandwdth_required_DL, and service_burst_bandwdth_required_UL.

In some embodiments, the electronic device may also receive, from the UE, application burst information. In embodiments such as these, after receiving the second indication, the electronic device may observe an application burst based on the application burst information, and in response to observing the application burst, the electronic device may initiate an allocation of radio resources that permits the UE to continuously receive XRM content during the application burst.

In some embodiments, the electronic device may also receive catch up time information for the XRM content, and detect a change in performance of the network. In response to the change in performance of the network, the electronic device may initiate a dropping by the network of remaining PDUs in a PDU set transporting XRM content of a current quality to the UE based on the catch up time information. The catch up time information can include at least one of a minimum, average, or maximum amount of time expected to be elapsed before the UE requests updated stream media components of the XRM content.

In some embodiments, the electronic device may also receive, from the UE, a request for a temporary service boost. The request can include one or more of the following parameters associated with the XRM content: a current resolution, current representation information, current adaptation information, a desired number of bursts, a current catch up time, a current burst periodicity, an initial content fetch interest, a desired service boost time, UE client information, or UE client application information. The electronic device may determine one or more delivery parameters for the temporary service boost based on the one or more parameters associated with the XRM content, and provide the one or more delivery parameters to one or more other network functions of the network.

In some embodiments, the electronic device may also receive, from the UE, a client tethered QoS specification, and determine a tethering configuration based on (i) the client tethered QoS specification, and (ii) the service/session configuration. In embodiments such as these, the electronic device may also provide the tethering configuration to the UE, the tethering configuration facilitating QoS management of tethered devices by the network function. The tethering configuration can include at least one of a synchronization configuration of tethered devices and data management notification information for data streams destined for the tethered devices.

In some embodiments, the electronic device may also receive, from the UE, capability information of tethered devices and tethered links, and determine a QoS configuration for the UE based on the capability information of the tethered devices and tethered links. In embodiments such as these the electronic device may also provide the QoS configuration to the UE, the QoS configuration delegating QoS management of the tethered devices to the UE. The QoS configuration can include at least one of: a packet loss requirement action map, a packet delay requirement action map, an inter stream delay requirement action map, and a bit rate requirement action map.

In some embodiments, the electronic device may also receive, from the UE, capability information of tethered devices and tethered links, and determine a content preparation configuration for the UE based on the capability information of tethered devices and tethered links. Embodiments such as these, the electronic device may provide the content preparation configuration to the UE. The UE may be configured to perform a content preparation procedure to send content to at least one of the tethered devices based on the content preparation configuration.

In some embodiments, the electronic device may also receive, from the UE, (i) energy status information of tethered devices, and (ii) capability information of the tethered devices and tethered links, and determine determining a content management configuration for the UE based on (i) the energy status information of the tethered devices, and (ii) the capability information of tethered devices and tethered links. In embodiments such as these, the electronic device may provide the content management configuration to the UE. The UE may be configured to perform a content management procedure based on the content management configuration.

In some embodiments, the electronic device may also receive, from the UE, capability information of tethered devices and tethered links, and determine a content adaptation configuration for the UE based on the capability information of tethered devices and tethered links. In embodiments such as these, the electronic device may provide the content adaptation configuration to the UE. The UE may be configured to perform a content adaptation procedure based on the content adaptation configuration and a current tethered device energy status.

Although FIG. 28 illustrates one example method for resource allocation and management of XRM services 2800, various changes may be made to FIG. 28. For example, while shown as a series of steps, various steps in FIG. 28 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method of operating a network function, the method comprising:
receiving, from an application service provider, a service/session configuration permitting a radio resource saving operation with a user equipment (UE) operating on a network of the network function;
receiving a first indication indicating that the UE has completed an initial content fetch of extended reality media (XRM) content from the application service provider;
in response to receiving the first indication, initiating the radio resource saving operation between the UE and the network;
receiving a second indication indicating receipt of additional XRM content for the UE from the application service provider; and
in response to receiving the second indication, initiating a termination of the radio resource saving operation between the UE and the network of the network function.

2. The method of claim 1, further comprising:
receiving or determining burst configuration information for the network;
after receiving the second indication, observing an application burst based on the burst configuration information; and
in response to observing the application burst, initiating an allocation of radio resources that permits the UE to continuously receive XRM content during the application burst,
wherein the burst configuration information includes at least one of:
burst_periodicity_post_initial_content_fetch;
burst_samples;
burst_interval;
burst_size;
service_burst_bandwdth_required_DL; and
service_burst_bandwdth_required_UL.

3. The method of claim 1, further comprising:
receiving, from the UE, application burst information;
after receiving the second indication, observing an application burst based on the application burst information; and
in response to observing the application burst, initiating an allocation of radio resources that permits the UE to continuously receive XRM content during the application burst.

4. The method of claim 1, further comprising:
receiving catch up time information for the XRM content;
detecting a change in a performance of the network; and
in response to the change in performance of the network, initiating a dropping by the network of remaining protocol data units (PDUs) in a PDU set transporting XRM content of a current quality to the UE based on the catch up time information,
wherein the catch up time information includes at least one of a minimum, average, or maximum amount of time expected to be elapsed before the UE requests updated stream media components of the XRM content.

5. The method of claim 1, further comprising:
receiving, from the UE, a request for a temporary service boost, wherein the request includes one or more of the following parameters associated with the XRM content:
a current resolution;
current representation information;
current adaptation information;
a desired number of bursts;
a current catch up time;
a current burst periodicity;
an initial content fetch interest;
a desired service boost time;
UE client information; or
UE client application information;
determining one or more delivery parameters for the temporary service boost based on the one or more parameters associated with the XRM content; and
providing the one or more delivery parameters to one or more other network functions of the network.

6. The method of claim 1, further comprising:
receiving, from the UE, a client tethered quality of service (QoS) specification;
determining a tethering configuration based on (i) the client tethered QoS specification, and (ii) the service/session configuration; and
providing the tethering configuration to the UE, the tethering configuration facilitating QoS management of tethered devices by the network function,
wherein the tethering configuration includes at least one of a synchronization configuration of tethered devices and data management notification information for data streams destined for the tethered devices.

7. The method of claim 1, further comprising:
receiving, from the UE, capability information of tethered devices and tethered links;
determining a quality of service (QoS) configuration for the UE based on the capability information of the tethered devices and tethered links; and
providing the QoS configuration to the UE, the QoS configuration delegating QoS management of the tethered devices to the UE,
wherein the QoS configuration includes at least one of:
a packet loss requirement action map;
a packet delay requirement action map;
an inter stream delay requirement action map; and
a bit rate requirement action map.

8. The method of claim 1, further comprising:
receiving, from the UE, capability information of tethered devices and tethered links;
determining a content preparation configuration for the UE based on the capability information of tethered devices and tethered links; and
providing the content preparation configuration to the UE,
wherein the UE is configured to perform a content preparation procedure to send content to at least one of the tethered devices based on the content preparation configuration.

9. The method of claim 1, further comprising:
receiving, from the UE, (i) energy status information of tethered devices, and (ii) capability information of the tethered devices and tethered links;
determining a content management configuration for the UE based on (i) the energy status information of the tethered devices, and (ii) the capability information of tethered devices and tethered links; and
providing the content management configuration to the UE,
wherein the UE is configured to perform a content management procedure based on the content management configuration.

10. The method of claim 1, further comprising:
receiving, from the UE, capability information of tethered devices and tethered links;
determining a content adaptation configuration for the UE based on the capability information of tethered devices and tethered links; and
providing the content adaptation configuration to the UE,
wherein the UE is configured to perform a content adaptation procedure based on the content adaptation configuration and a current tethered device energy status.

11. An electronic device comprising:
at least one processor including processing circuitry; and
memory storing instructions, wherein the instructions, when executed by the at least one processor individually or collectively, cause the electronic device to:
receive, from an application service provider, a service/session configuration permitting a radio resource saving operation with a user equipment (UE) operating on a network of the electronic device;
receive a first indication indicating that the UE has completed an initial content fetch of extended reality media (XRM) content from the application service provider;
in response to receiving the first indication, initiate the radio resource saving operation between the UE and the network;
receive a second indication indicating receipt of additional XRM content for the UE from the application service provider; and
in response to receiving the second indication, initiate a termination of the radio resource saving operation between the UE and the network of the electronic device.

12. The electronic device of claim 11, wherein the instructions, when executed by the at least one processor individually or collectively, further cause the electronic device to:
receive or determine burst configuration information for the network;
after receiving the second indication, observe an application burst based on the burst configuration information; and
in response to observing the application burst, initiate an allocation of radio resources that permits the UE to continuously receive XRM content during the application burst,
wherein the burst configuration information includes at least one of:
burst_periodicity_post_initial_content_fetch;
burst_samples;
burst_interval;
burst_size;
service_burst_bandwdth_required_DL; and
service_burst_bandwdth_required_UL.

13. The electronic device of claim 11, wherein the instructions, when executed by the at least one processor individually or collectively, further cause the electronic device to:
receive, from the UE, application burst information;
after receiving the second indication, observe an application burst based on the application burst information; and
in response to observing the application burst, initiate an allocation of radio resources that permits the UE to continuously receive XRM content during the application burst.

14. The electronic device of claim 11, wherein the instructions, when executed by the at least one processor individually or collectively, further cause the electronic device to:
receive catch up time information for the XRM content;
detect a change in a performance of the network; and
in response to the change in performance of the network, initiate a dropping by the network of remaining protocol data units (PDUs) in a PDU set transporting XRM content of a current quality to the UE based on the catch up time information,
wherein the catch up time information includes at least one of a minimum, average, or maximum amount of time expected to be elapsed before the UE requests updated stream media components of the XRM content.

15. The electronic device of claim 11, wherein the instructions, when executed by the at least one processor individually or collectively, further cause the electronic device to:
receive, from the UE, a request for a temporary service boost, wherein the request includes one or more of the following parameters associated with the XRM content:
a current resolution;
current representation information;
current adaptation information;
a desired number of bursts;
a current catch up time;
a current burst periodicity;
an initial content fetch interest;
a desired service boost time;
UE client information; or
UE client application information;
determine one or more delivery parameters for the temporary service boost based on the one or more parameters associated with the XRM content; and
provide the one or more delivery parameters to one or more other network functions of the network.

16. The electronic device of claim 11, wherein the instructions, when executed by the at least one processor individually or collectively, further cause the electronic device to:
receive, from the UE, a client tethered quality of service (QoS) specification;
determine a tethering configuration based on (i) the client tethered QoS specification, and (ii) the service/session configuration; and
provide the tethering configuration to the UE, the tethering configuration facilitating QoS management of tethered devices by the electronic device,
wherein the tethering configuration includes at least one of a synchronization configuration of tethered devices and data management notification information for data streams destined for the tethered devices.

17. The electronic device of claim 11, wherein the instructions, when executed by the at least one processor individually or collectively, further cause the electronic device to:
receive, from the UE, capability information of tethered devices and tethered links;
determine a quality of service (QoS) configuration for the UE based on the capability information of the tethered devices and tethered links; and
provide the QoS configuration to the UE, the QoS configuration delegating QoS management of the tethered devices to the UE,
wherein the QoS configuration includes at least one of:
a packet loss requirement action map;
a packet delay requirement action map;
an inter stream delay requirement action map; and
a bit rate requirement action map.

18. The electronic device of claim 11, wherein the instructions, when executed by the at least one processor individually or collectively, further cause the electronic device to:
receive, from the UE, capability information of tethered devices and tethered links;
determine a content preparation configuration for the UE based on the capability information of tethered devices and tethered links; and
provide the content preparation configuration to the UE,
wherein the UE is configured to perform a content preparation procedure to send content to at least one of the tethered devices based on the content preparation configuration.

19. The electronic device of claim 11, wherein the instructions, when executed by the at least one processor individually or collectively, further cause the electronic device to:
receive, from the UE, (i) energy status information of tethered devices, and (ii) capability information of the tethered devices and tethered links;
determine a content management configuration for the UE based on (i) the energy status information of the tethered devices, and (ii) the capability information of tethered devices and tethered links; and
provide the content management configuration to the UE,
wherein the UE is configured to perform a content management procedure based on the content management configuration.

20. The electronic device of claim 11, wherein the instructions, when executed by the at least one processor individually or collectively, further cause the electronic device to:
receive, from the UE, capability information of tethered devices and tethered links;
determine a content adaptation configuration for the UE based on the capability information of tethered devices and tethered links; and
provide the content adaptation configuration to the UE,
wherein the UE is configured to perform a content adaptation procedure based on the content adaptation configuration and a current tethered device energy status.
